(19) United States
(12) Patent Application Publication
(10) Pub. No.: US 2024/0158107 A1
(43) Pub. Date: May 16, 2024

(54) MULTIPORT CONVERTERS, MULTIPLE-INPUT MULTIPLE-OUTPUT CONVERTERS, AND POWER-DOWN MODES FOR SATELLITE ELECTRIC POWER SYSTEMS

(71) Applicant: Khalifa University of Science and Technology, Abu Dhabi (AE)

(72) Inventors: Amarendra EDPUGANTI, Abu Dhabi (AE); Vinod Madhavrao KHADKIKAR, Abu Dhabi (AE); Hatem ZEINELDIN, Abu Dhabi (AE); Mohamed Shawky EL MOURSI, Abu Dhabi (AE)

(21) Appl. No.: 18/549,467

(22) PCT Filed: Mar. 11, 2022
(86) PCT No.: PCT/IB2022/052183

§ 371 Date: Sep. 7, 2023

Related U.S. Application Data
(60) Provisional application No. 63/159,836, filed on Mar. 11, 2021.

(51) Int. Cl. B64G 1/44; B64G 1/10; B64G 1/42; H02J 7/00; H02J 7/35

(52) U.S. Cl. CPC B64G 1/443; B64G 1/10; B64G 1/428; H02J 7/0013; H02J 7/35; H02J 2207/20

(57) ABSTRACT

The application discloses a compact, multiport converter for interfacing photovoltaic (PV) panels to an energy storage system of a CubeSat. The multiport converter includes a series of connected half-bridge modules, fed by PV panels, that supplies the energy storage system. Further, a control strategy allows the multiport converter to extract a maximum amount of solar power from PV panels under varying irradiation conditions. One example multiport converter includes a multiple-input multiple-output converter that achieves a smaller footprint by utilizing a single inductor for transferring energy. Some aspects also enhance a fault-tolerance capability of CubeSats using a new EPS architecture, for example, by providing independent converters for maximum power point tracking of PV panels. The fault-tolerance capabilities are further enhanced by a new power-down mode for generation and load-side converters.

### CROSS-REFERENCE TO RELATED APPLICATIONS

This application claims the benefit of U.S. Provisional Application No. 63/159,836 filed Mar. 11, 2021, the entire contents of which are hereby incorporated for all purposes in their entirety.

### BACKGROUND

A CubeSat is a type of nanosatellites used for space research due to lower cost and faster deployment. CubeSats require reliable operation of an electrical power system (EPS) that powers all of their respective subsystems. The successful mission of CubeSats depend on an EPS that powers all the other subsystems and payloads. Several studies have shown that EPS failure is often a main contributor for a CubeSat mission failure. The EPS is a crucial subsystem for CubeSat operation. The typical architecture of CubeSat EPS can be analogized to a flying micro-grid with photovoltaic (PV) panels for power generation, lithium-on (Li-Ion) batteries for energy storage, and direct current (DC)-to-DC converters for energy conversion and load voltage regulation (VR). The power generated by each panel depends on the irradiation of each PV panel. In case of fixed panel arrangement, irradiation profile of each panel completely differ from each other as the CubeSat rotates in the orbit.

### BRIEF SUMMARY OF THE DISCLOSURE

CubeSats rely on power generated by panels (e.g., PV panels). The power generated by PV panels depend on an amount of irradiation (e.g., solar irradiation) received by each PV panel. However, irradiation profiles for each given PV panel may differ completely from one other. For instance, irradiation profiles may vary widely while a particular CubeSat rotates in the orbit. As a result, PV panels are typically interfaced with a dedicated DC-to-DC converter for achieving maximum power point tracking (MPPT). The output of such MPPT converters are frequently connected to battery cells, which supplies power to loads during times associated with an eclipse or when a load demand is higher than power generation. But this configuration has a significant negative trade-off: an increased footprint of a printed circuit board (PCB), which is caused by multiple, bulky inductors.

Maximization of solar energy harvest and miniaturization of converters are essential for low earth orbit (LEO) CubeSats which are constrained by volume and weight restrictions. Some existing EPS architectures utilize multiple DC-to-DC converters to maximize solar energy harvest, but doing so requires a volumetric trade-off with miniaturization that is caused by using multiple inductors. For example, some existing power systems utilize architectures that include multiple DC-to-DC converters for MPPT tracking and load voltage regulation (VR). But these existing power systems often have architectures that achieve such results by employing multiple inductors.

There are several disadvantages of using multiple inductors to achieve MPPT, including added weight to the CubeSat, and added impedance that can result in energy losses or inefficiencies. Instead, some existing power systems propose using multiport converters in smaller satellite applications. But few existing power systems do so because typically, multiport converters also require an isolation transformer to transfer alternating current (AC) to a powered device. And generally isolation transformers are wholly unsuitable for CubeSats, given their unwieldy footprint and proportional mass.

Managing component failures in MPPT or load-side converters are critical for CubeSat mission. The effect of component failure on circuit operation can be catastrophic, thus there is a need to develop strategies for fault detection and reconfiguration. Fault analysis may include failures of components such as semiconductor devices, microcontrollers (MCUs), and/or power supplies to MCUs and gate drivers. In general, fault analysis does not include failures of passive components that are one order of magnitude lower than semiconductor devices.

The EPS of a satellite is like the heart of satellite that powers all the subsystems. It can be viewed as a flying micro-grid with primary, and rechargeable energy sources, power regulation control, power distribution, and protection systems. Reliable operation of EPS is important for successful mission of satellites as there is no possibility of maintenance after its launch. However, failure rate of EPS in the range of 28-44% remains as one of the major factors in mission failure of satellites. Field experiences reveal that the power semiconductor devices are one of the most vulnerable components in the satellite EPS.

In existing power systems, generally, once a CubeSat is launched and settled in its designated orbit, power converters in the CubeSat's EPS will operate continuously irrespective of an amount of solar irradiation and/or load demand. For example, switches of load side converters are controlled to maintain a reference output voltage even under no-load condition. This continuous operation of converters, even when there is no power processed, imposes both electrical and thermal stresses on power converters and thus, reduce their overall lifespan. Thus, the reliability of semiconductor devices can be significantly improved by reducing operational, electrical, thermal, and mechanical stresses.

Certain aspects of this disclosure include a compact multiport converter for interfacing with PV panels to energy storage system of the LEO CubeSat. For example, certain aspects include a new compact multiport converter for interfacing the PV panels to battery storage system for a CubeSat's EPS. The compactness multiport converter may be achieved by utilizing a single inductor for transferring energy from PV panels to a Li-Ion battery cell. One example topology includes a series connected half-bridge (HB) modules fed by PV panels and their output is supplied to the energy storage system via a boost converter. Further, a principle of operation is introduced followed by steady-state analysis and converter dynamics analysis. Also, a control strategy has been developed to extract maximum solar power from each PV panel under wide varying irradiation conditions for the LEO CubeSats. The performance of proposed converter is verified for several case studies with EPS architecture developed based on IU CubeSat requirements.

Certain aspects of this disclosure enhance an overall fault-tolerance of a CubeSat by proposing a new EPS architecture as well as by introducing a new mode of operation. The proposed architecture introduces independent converters for maximum power point tracking operation of PV panels by utilizing the space available on the back-side of PV panels. This is possible by using gallium nitride field-effect transistors to reduce the converter footprint. Certain aspects include a single inductor-based N−1 redundant converters, for generation and load-side, are proposed to provide uninterrupted operation.

Certain aspects of this disclosure include a new mode of operation termed as power-down mode to operate the power electronic converters of the satellite EPS. The power-down mode can switch-off semiconductor devices when an amount of power that is processed falls below a threshold level and/or during a no-load operation. In particular, a method to switch-off semiconductor devices of power electronic converters based on the power processed is proposed to improve the reliability of EPS. Further, the power-down mode can minimize a failure rate of semiconductor devices, for example, by reducing an amount of electrical and thermal stress on the semiconductor devices, as well as the switching losses and thus, the lifespan of the semiconductor devices can be improved. Further, certain aspects are validated with detailed simulation studies of an IU CubeSat EPS. While the logic to activate power-down mode differs for generation-side and load-side converters, the power-down mode is applicable in any satellite EPS. Thus, the power-down mode may be applied to both generation-side converters and load-side converters. The invention also includes an ability to perform a power reset of a CubeSat from the ground station, for example, by utilizing a control signal from a transceiver to control a switch that is connected to a power source.

Certain aspects of this disclosure include anew multiple-input multiple-output (MIMO) converter for the CubeSat's EPS. The inventive converter topology achieves a smaller footprint compared to existing EPS systems, for example, due to a utilization of a single inductor for transferring energy from PV panels to loads and/or Li-Ion battery cell.

### BRIEF DESCRIPTION OF THE DRAWINGS

Various features, aspects, and advantages in accordance with the present disclosure will be described with reference to the drawings.

FIG. 1 depicts an example of a conventional EPS architecture for CubeSats.

FIG. 2 depicts an example satellite constellation in a LEO, according to certain aspects of the present disclosure.

FIG. 3 illustrates an example of components for a CubeSat, according to certain aspects of the present disclosure.

FIG. 4 depicts example classifications of DC-to-DC power converters for distributed maximum power point tracking (DMPPT) architectures, according to certain aspects of the present disclosure.

FIG. 5 depicts examples of DMPPT architectures, including a full power processor (FPP) and a differential power processor (DPP) architecture, according to certain aspects of the present disclosure.

FIG. 6 depicts an example of a converter topology for a PV-to-PV DPP architecture, according to certain aspects of the present disclosure.

FIG. 7 depicts another example of a converter topology for a PV-to-PV DPP architecture, according to certain aspects of the present disclosure.

FIG. 8 depicts another example of a converter topology for a PV-to-PV DPP architecture, according to certain aspects of the present disclosure.

FIG. 9 depicts an example of a multiport converter topology for a CubeSat EPS, according to certain aspects of the present disclosure.

FIG. 10 depicts examples of modes of operation for a switched capacitor converter (SCC) in a multiport converter for a CubeSat EPS, according to certain aspects of the present disclosure.

FIG. 11 depicts additional examples of modes of operation for multiport converters in a CubeSat EPS, according to certain aspects of the present disclosure.

FIG. 12 depicts multiple views of an example PCB for a multiport converter in a CubeSat EPS, according to certain aspects of the present disclosure.

FIG. 13 depicts examples of gating signals of a multiport SCC and a boost converter for a multiport converter of a CubeSat EPS, according to certain aspects of the present disclosure.

FIG. 14 depicts examples of estimated duty-cycles of a multiport converter for an IU CubeSat in a full orbit, according to certain aspects of the present disclosure.

FIG. 15 depicts another example of a multiport converter topology for a CubeSat EPS, according to certain aspects of the present disclosure.

FIG. 16 depicts another example of an EPS architecture for a CubeSat EPS, according to certain aspects of the present disclosure.

FIG. 17 depicts yet another example of an EPS architecture for a CubeSat EPS, according to certain aspects of the present disclosure.

FIG. 18 depicts an example of an operating mode using an input voltage of a camera in an imaging mode orbit, according to certain aspects of the present disclosure.

FIG. 19 depicts examples of simulation results for solar irradiation on a pair of Y-axis facets of a CubeSat in orbit, according to certain aspects of the present disclosure.

FIG. 20 depicts examples of simulation results for solar irradiation on each facet of a CubeSat in orbit, according to certain aspects of the present disclosure.

FIG. 21 depicts examples of simulation results for solar irradiation and gating signals of a redundant MPPT converter on a particular facet of a CubeSat in orbit, according to certain aspects of the present disclosure.

FIG. 22 depicts another example of simulation results for a load-side buck converter in a CubeSat EPS, according to certain aspects of the present disclosure.

FIG. 23 illustrates an example flow-chart of a power-down mode for load-side converters, according to certain aspects of the present disclosure.

FIG. 24 illustrates an example flow-chart of a power-down mode for generation-side converters, according to certain aspects of the present disclosure.

FIG. 25 illustrates an example flow-chart for periodic and ground controlled CubeSat reset, according to certain aspects of the present disclosure.

FIG. 26 shows an example computing device for performing certain aspects of the present disclosure.

FIG. 27 illustrates another example of components of a CubeSat, according to certain aspects of the present disclosure.

### DETAILED DESCRIPTION OF THE DISCLOSURE

In the following description, various embodiments will be described. For purposes of explanation, specific configurations and details are set forth in order to provide a thorough understanding of the embodiments. However, it will also be apparent to one skilled in the art that the embodiments may be practiced in other configurations, or without the specific details. Furthermore, well-known features may be omitted or simplified in order not to obscure the embodiment being described. Specific embodiments are described in detail below, with reference to the figures.

CUBESATS have been most popular for space research due to lower cost, faster production, and easier deployment. Among the different subsystems of CubeSat, the EPS is the most critical as it harvests energy from the Sun and supplies it to all other subsystems such as communication system, payloads, on-board computer etc. CubeSats EPS can be seen as a flying micro-grid with PV panels for energy generation. Li-Ion batteries for energy storage, power electronic converters for energy conversion and load consumption, power distribution system, and protection system. The PV panels can be either fixed on the facets or deployable or combination of both.

Deployable panels offer certain advantages since they can be oriented towards the Sun to generate maximum power at any time instance. For LEO CubeSats, PV panels may or may not receive same irradiation depending on their mechanical arrangement. Certain aspects of this disclosure use fixed panel CubeSats in which the panels have widely different irradiation profiles. Nonetheless, the same principles hold true for deployable panel-based CubeSats, in which at least one of the panels have different irradiation profile.

Certain aspects of the present disclosure include a compact single inductor converter topology for LEO CubeSats to interface PV panels to energy storage system. The proposed converter is a type of series FPP architecture but it utilizes switched capacitor converters (SCCs) for interfacing the PV panels instead of converters with the inductive element. The output of SCCs is fed to the central DC-to-DC converter and its output is connected to energy storage system. Further, the present disclosure includes principles of converter operation, steady-state analysis, details of converter design, and analysis of converter dynamics.

Certain aspects include a control strategy for SCCs and a central DC-to-DC converter achieves a true MPPT operation for each PV panel under a wide-range of operating conditions. For example, each SCC may be controlled to keep the capacitor voltage close to a maximum power-point (MPP) voltage, whereas the boost converter is operated in hysteresis control mode to keep the inductor current within designed limits.

Certain aspects of the disclosure include a power system that has been developed based on IU CubeSat specification to validate the converter performance. To validate the proposed concepts, the multiport converters may be based on IU CubeSat specifications, and its performance is validated for several operating conditions. The results indicate that the proposed converter achieves similar conversion efficiency while reducing the two bulkier inductors compared to existing EPS architectures of CubeSats. The space that is freed up by the compact converters described herein can be utilized for optimizing a placement of critical components to improve an overall reliability of a CubeSat EPS.

Certain aspects of this disclosure include an EPS architecture for CubeSats that can enhance an overall fault-tolerance capability. In one example, the EPS architecture includes dedicated converters for the MPPT of PV panels to reduce an amount of electrical and thermal stresses placed on semiconductor devices. Additional converters are incorporated by utilizing an amount of free space that is available on a back-side of each PV panel. In some examples, a fault-tolerance of the EPS architecture may be improved using N−1 redundant converters for generation-side converters, as well as load-side converters.

For example, redundant converters can use a common inductor and half-bridge switch modules to minimize an overall footprint of the EPS architecture, thereby conforming to space requirements on an EPS board (e.g., PCB). In other examples, an operating mode may be used to improve fault-tolerance. For example, a power-down mode may be implemented using power generation profiles and load consumption profiles In one example, the power-down mode uses switching signals to turned off semiconductor devices during low or no power conditions. Further, the EPS architecture may be validated and designed using IU CubeSat data from MySat-1 and simulations for case studies.

### Examples of Conventional EPS Architectures

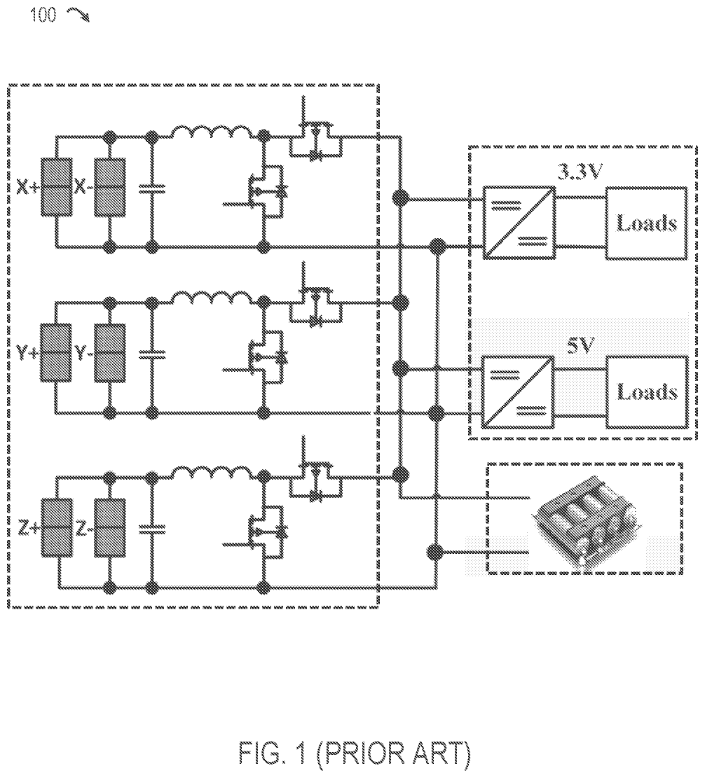

FIG. 1 depicts an example of a conventional EPS architecture 100 for CubeSats. The conventional EPS architecture 100 of a CubeSat shown in FIG. 1 includes fixed solar panels. The conventional EPS architecture 100 also includes PV panels for power generation, batteries for energy storage, and DC-to-DC converters for an MPPT operation of PV panels and a load VR. The PV panels on the opposite sides of the CubeSat are connected in parallel as only one of the panel receives irradiation at any point of time. Each set of PV panels are interfaced with a dedicated DC-to-DC converter for MPPT operation as the irradiation profile of each panel completely differ from each other as the CubeSat rotates in the orbit. The output of MPPT converters are connected in parallel to battery cells, which supplies power to loads during eclipse time or when the load demand is higher than power generation. The load equipment has dedicated DC-to-DC converters for supplying regulated DC voltages. One disadvantage of this configuration is an increase in an overall footprint of the PCB that is caused by multiple, bulky inductors that are used with each DC-to-DC converter.

The conventional EPS architecture 100 includes PV panels. Generally, these PV panels are positioned on opposite facets and are connected in parallel as only one of the facets receive solar irradiation at any time instance. To achieve a true MPPT operation, despite a wide mismatch of irradiation levels, the existing EPS architectures 100 utilizes independent DC-to-DC converters for each set of PV panels. The output of the MPPT converters is connected in parallel to the energy storage system such as a battery. During a sunlit period, the load demand is supplied by either the PV panels or combination of PV panels and battery. During an eclipse, the entire load demand is supplied by the battery. Thus, the battery gets charged or discharged depending on whether a load demand is lower or higher than a power generation, respectively.

The conventional CubeSat EPS 100 illustrated in FIG. 1 is a type of parallel FPP architecture, wherein the output of each DC-to-DC converter is connected in parallel across battery terminals. The conventional CubeSat EPS 100 achieves MPPT under varying irradiation conditions, but it does so at a cost of miniaturization due to multiple inductors.

### Examples of CubeSat Architectures

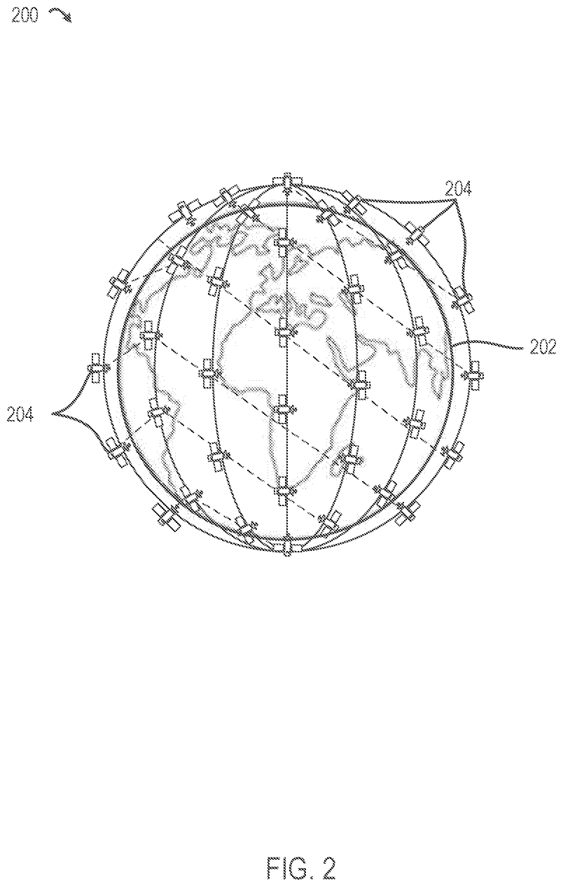

FIG. 2 depicts an example satellite constellation 200 in LEO, according to at least one example. A satellite constellation 200 includes a number of satellites 204 working in concert. The satellites 204 may have coordinated ground coverage and operate together under a shared control to ensure complete coverage and overlaps in coverage. The satellites 204 may all be at the same or nearly the same altitude over the Earth 202. In this example, the satellite constellation 200 includes multiple satellites 204, however, it should be appreciated that the satellite constellation 200 may include fewer satellites 204. For instance, in one example, the number of satellites 204 may be a single CubeSat or any other suitable number. Further, in some examples, the satellites 204 may not necessarily form a satellite constellation 200.

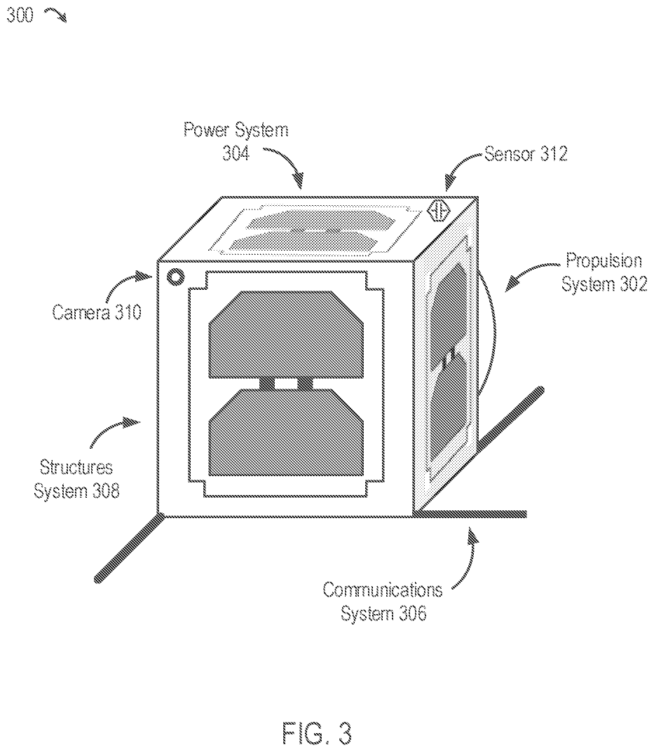

FIG. 3 illustrates an example of components of a CubeSat 300, according to certain aspects of the present disclosure. As illustrated, the CubeSat 300 includes, among other components, a propulsion system 302, a power system 304, a communications system 306, a structures system 308, a camera 310, and a sensor 312.

In one example, the propulsion system 302 includes one or more motors (e.g., rocket motors) that may move the CubeSat 300 in a position within an orbit. The propulsion system 302 also includes as thrusters to maintain the CubeSat 300 in its position. The thrusters can also be used to move the CubeSat 300 back into position in the orbit due to, for instance, solar wind or gravitational or magnetic forces.

In this example, the power system 304 generates electricity from the solar panels deployed on the outside of the CubeSat 300. The solar panels also store electricity in a set of storage batteries installed within the structures system 308. The set of storage batteries can provide power at times when the panels do not receive rays from the sun. The power is used to operate various systems of the CubeSat 300, including the communications system 306.

The communications system 306 handles receive and transmit functions. Further, the communications system 306 receives signals from a source, amplifies them, and transmits them to a destination. The source can be user equipment on the Earth or another satellite. The destination is typically different from the source and includes user equipment on the Earth or another satellite.

The structures system 308 provides a stable set of structures so that the CubeSat 300 can be kept in position. The structures system 308 can also house components of other systems, such as subsystems of the power system 304 (e.g., the storage batteries, power converters, and the like) and subsystems of the communications system 306 (e.g., receivers, transmitters, and the like). Other components can also be housed within the structures system 308. For instance, a thermal control system is contained in the structures system 308. The thermal control system keeps components of the CubeSat 300 within their operational temperature ranges.

A control system is also contained in the structures system 308. The control system orients the CubeSat 300 precisely to maintain the proper position. When the satellite gets out of position, the control system instructs the propulsion system 302 to control one or more thrusters to move the CubeSat 300 back in position. The control system also includes tracking, telemetry, and control subsystems for monitoring vital operating parameters of the CubeSat 300, telemetry circuits for relaying this information to user equipment on the Earth, a system for receiving and interpreting commands sent to the CubeSat 300 from the user equipment or another satellite, and a command system for controlling the operation of the CubeSat 300.

The example CubeSat 300 includes the camera 310, which is capable of capturing images. For example, the camera 310 can take images while in LEO that include images of the Earth. The camera 310 may be an image processing device that is licensed, for example, by the National Oceanic and Atmospheric Administration (NOAA) to capture images of the Earth. In some examples, the camera 310 may send one or more images to a remote computing device, such as a ground station. Further, the camera 310 may send such images in any suitable digital format. In some examples, the camera 310 sends the images as a radio frequency (RF) transmission. The camera 310 can be an analog, digital, video, high-resolution or any other suitable type of image capture device.

Continuing with this example, the CubeSat 300 further includes the sensor 312. The sensor 312 can capture and report sensor data. For instance, the sensor 312 may be capable of capturing and reporting one or more types of measurements as sensor data. In some examples, the sensor 312 may include an angular rate sensor, attitude sensor, global positioning system (GPS) receiver, imager, irradiation sensor, microwave sensor, millimeter-wave radiometer, optical sensor, temperature sensor, or any other suitable type of sensor.

In some examples, the example components of CubeSat 300 may be implemented in any suitable type of satellite. For instance, the example components of the CubeSat 300 may be implemented in a communications satellite, remote sensing satellite, navigation satellite, drone, ground satellite, polar satellite, etc. Further, the EPS architectures and their respective operations may be applied to these additional types of satellites, for example, using any of the techniques described herein. In some examples, the EPS architectures described herein may employ different types of power sources (e.g., other than PV panels) or different types of charging systems (e.g., other than rechargeable batteries).

### Examples of Converter Topologies for CubeSat Architectures

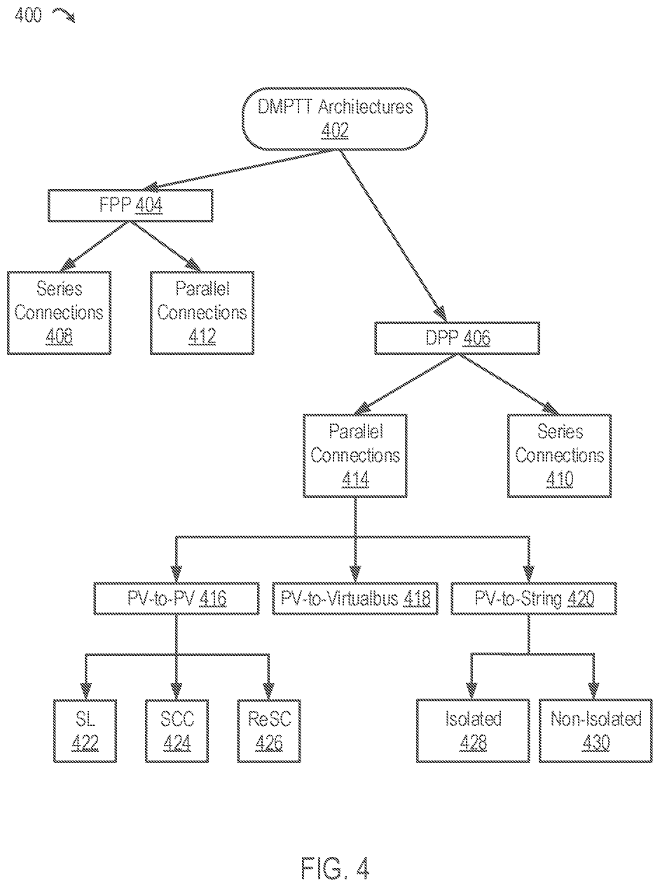

FIG. 4 depicts example classifications 400 of DC-to-DC multiport power converters for distributed MPPT (DMPPT) architectures 402, according to certain aspects of the present disclosure. For terrestrial PV systems, DMPPT architectures 402 shown in FIG. 4 maximize an amount of energy harvested during mismatch conditions (partial shading, panel degradation, etc.). Typically, DMPPT solutions are broadly classified into FPP architectures 404 and DPP architectures 406. For instance, FPP architectures 404 may include serial-connected FPPs 408 and parallel-connected FPPs 412.

However, DPP architectures 406 may include a greater number of variants. For instance, the DPP architectures 406 may be implemented as either a series-connected DPP 410 or a parallel-connected DPP 414. In some examples, a series-connected DPP architecture 410 may be more efficient, and thus, more appropriate for a grid-tied inverter system. In other examples, a parallel-connected DPP architecture 414 may be further divided into PV-to-PV DPP architectures 416, PV-to-Virtualbus architectures 418, and PV-to-String DPP architectures 420. Further, PV-to-PV DPP architectures 416 may include switch-inductor (SL) DPP architectures 422, SCC DPP architectures 424, and resonant switched-capacitor converter (ReSC) DPP architectures 426. In some examples, SCC DPP architectures 424 may be further categorized as an adjacent PV-to-PV, direct PV-to-PV, or capacitor-less SCC.

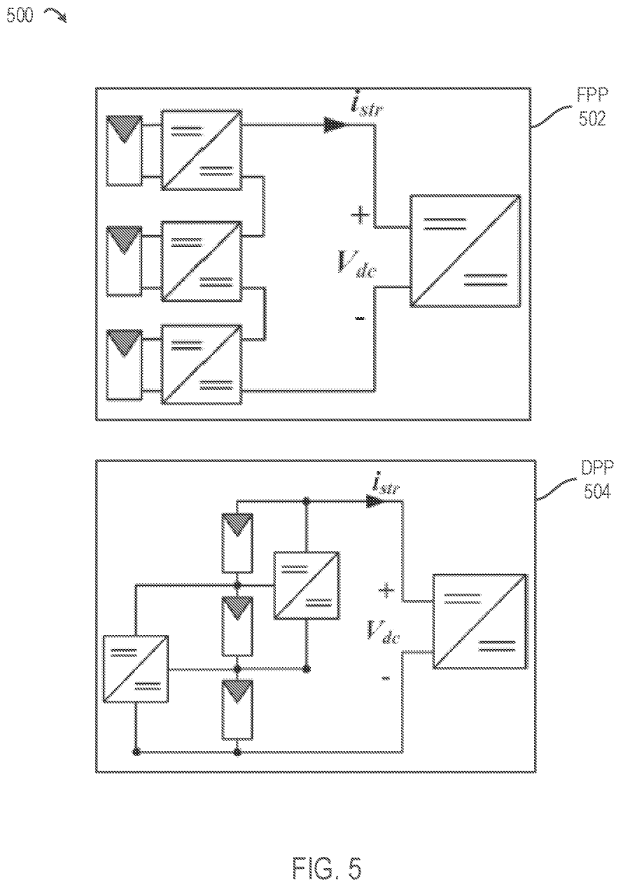

FIG. 5 depicts examples of DMPPT architectures 500, including a FPP architecture 502 and a PV-to-PV DPP architecture 504, according to certain aspects of the present disclosure. In this example, the FPP architecture 502 includes dedicated DC-to-DC power converters for each PV panel. These dedicated power converters allow the FPP architecture 502 to achieve a true MPPT under wide-range of irradiation conditions.

The PV-to-PV DPP architecture 504 uses multiple power converters to handle mismatches in amounts of power generated between adjacent panels. The PV-to-PV DPP architecture 504 can thereby only handle such mismatches, while keeping intact series connections between PV panels. Thus, the PV-to-PV DPP architecture 504 provides a bulk power flow that can be processed by a central converter for MPPT tracking. The effect of the PV-to-PV DPP architecture 504 is not only a minimization of a conversion loss, but also a significant reduction in a size and cost of powered electronics.

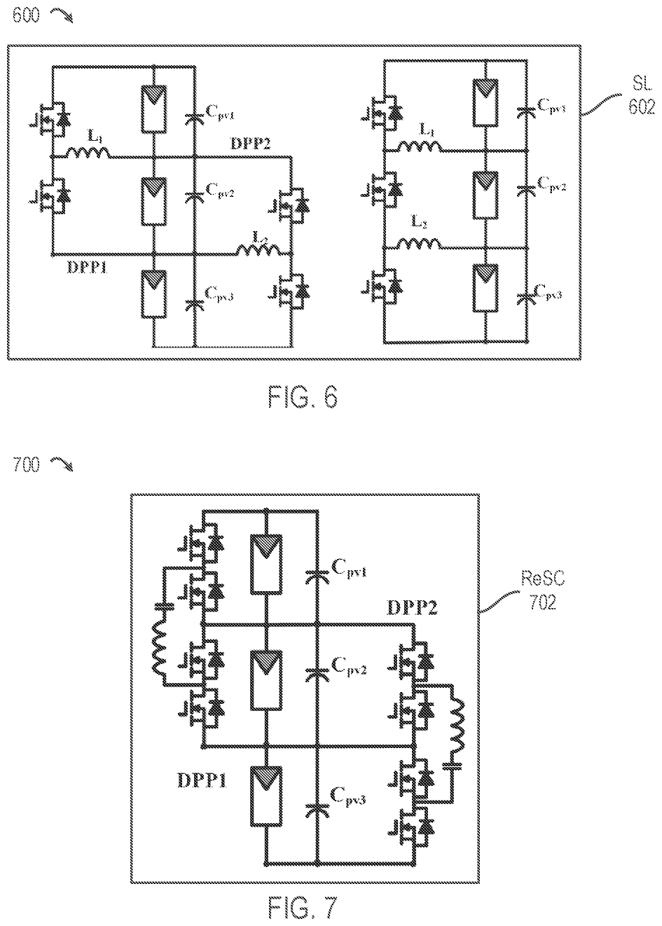

FIG. 6 depicts an example of a converter topology for a PV-to-PV DPP architecture 600, according to certain aspects of the present disclosure. In this example, FIG. 6 show is an example of a converter topologies under a PV-to-PV DPP architecture 600 that includes a SL converter topology 602.

FIG. 7 depicts another example of a converter topology for a PV-to-PV DPP architecture 700, according to certain aspects of the present disclosure. In this example, FIG. 7 shows converter topologies under a PV-to-PV DPP architecture 700 that includes a ReSC converter topology 702.

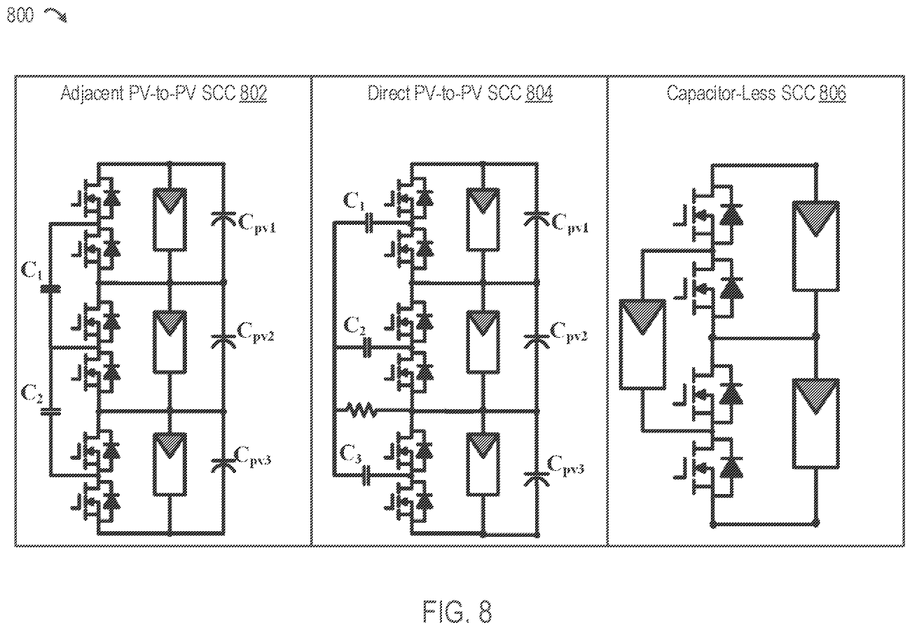

FIG. 8 depicts another example of a converter topology for a PV-to-PV DPP architecture 800, according to certain aspects of the present disclosure. In this example, FIG. 8 shows examples of converter topologies under PV-to-PV DPP architectures 800 that includes examples of SCC converters 802, 804, and 806. Generally, the SCC-based PV-to-PV DPP architectures 800 offer more compact solutions as they need only one inductor in a central DC-to-DC converter for MPPT tracking. However, SCC-based PV-to-PV DPP architectures 800 do not necessarily guarantee a true MPPT operation of each PV panel because MPP voltages may not be equal (e.g., under different irradiation conditions).

The SCC-based PV-to-PV DPP architectures 800 may be further categorized, for example, including an adjacent PV-to-PV SCC 802, direct PV-to-PV SCC 804, and capacitor-less SCC 806. In some examples, an SCC-based PV-to-PV DPP architecture 800 can be combined with a single inductive storage element to operate PV panels under higher partial shading conditions. In one example, a single inductive storage element can operate PV panels for a higher conversion efficiency that is offered for up to an 80% mismatch.

Each of the different DMPPT solutions, as shown in the converter topologies for PV-to-PV DPP architectures shown in FIGS. 6-8, may be used achieve miniaturization for a CubeSat EPS. For LEO CubeSats, a PV-to-PV DPP architecture may be preferred over a PV-to-Virtualbus architecture or a PV-to-String architecture because each requires either multiple inductors or bulky isolation transformers. Due to a 100% mismatch of irradiation levels in CubeSat PV panels. PV-to-PV DPP architectures require that a converter be designed for a full current rating of its PV panel. This design requirement strongly implies that SL and ReSC topologies would still require three inductors of a similar rating to be implemented in the CubeSat. Thus, the SL and ReSC often face the same challenges as some existing solutions, providing no discernable benefit in compactness.

But some SCC-based DPP architectures (e.g., SCC converters 802, 904, and 906) for CubeSats can eliminate two inductors, thereby utilizing a smaller converter footprint compared to conventional EPS designs. However, this configuration alone does not guarantee a true MPPT operation even for terrestrial applications, nevertheless in cases of CubeSats with a 100% mismatch of irradiation levels on PV panels. Certain aspects described herein address these needs with a new converter topology for CubeSats that achieves miniaturization, while maximizing an amount of solar energy harvested.

### Examples of Implementation Techniques for Converter Topologies

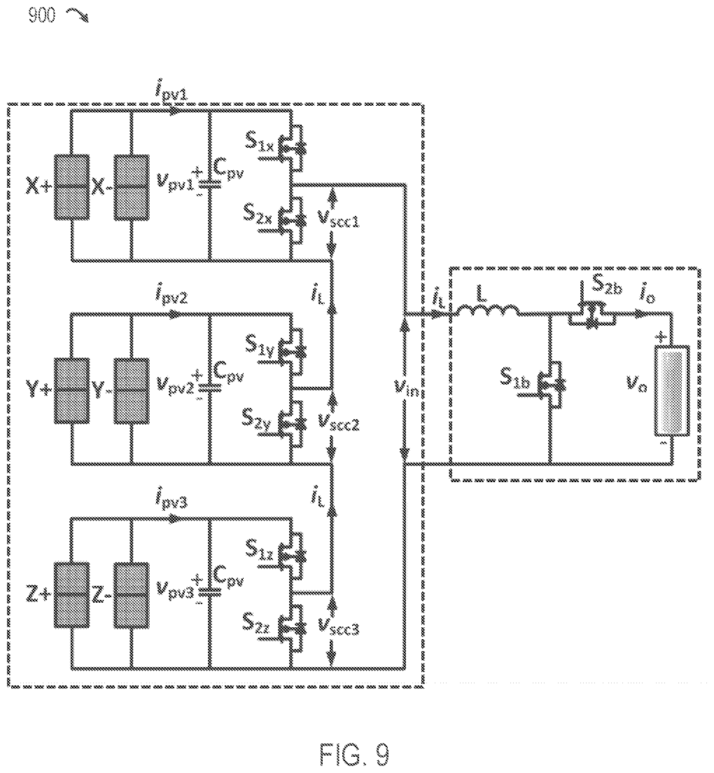

FIG. 9 depicts an example of a multiport converter topology 900 for a CubeSat EPS, according to certain aspects of the present disclosure. On the generation side, multiport converter topology 900 includes PV panels on opposite sides that are connected in parallel to a capacitor and a half-bridge (HB) module, which is together referred as a switching capacitor converter (SCC). In this example, the SCCs are connected in series. The output of the SCCs are fed from their respective HB modules to loads and battery terminals via the inductor. In each SCC, the PV panel current iₚᵥ, transfers energy from panel to capacitor Cₚᵥ and its output current i_{L} transfers the energy from the capacitor Cₚᵥ to an inductive element or battery terminals. The extracted power from the PV panels gets stored in inductive element when S_{1b} is ‘ON,’ and it is fed to battery terminals when S_{2b} is ‘ON.’

In this example, the multiport converter topology 900 may operate in a number of ways. For example, in a bypass mode, the PV panel current iₚᵥ charges the capacitor Cₚᵥ, whereas a net current of iₚᵥ−i_{L}, flows into the capacitor Cₚᵥ in the insertion mode. The value of i_{L} is controlled to be always higher than maximum PV panel current and thus, the capacitor Cₚᵥ gets discharged in the insertion mode In other words, the energy from the PV panels is transferred to the capacitor Cₚᵥ in the bypass mode and the energy from the capacitor Cₚᵥ is transferred to inductor or battery terminals in the insertion mode. The value of vᵢₙ depends on the inserted voltages of each SCC, which varies according to the irradiation of their PV panels. The boost converter is operated in current control mode such that i_{L} is maintained above the maximum PV panel current. In this way, the MPPT operation for each of the PV panels is guaranteed for all irradiation conditions.

In some examples, implementation techniques may vary for certain components of multiport converters. For example, implementations for inductors, capacitors, or an inductor current reference may be optimized when considering operating conditions of the CubeSat. In some examples, semiconductor devices may be assumed to operate with a switching frequency that is equal to Fₛ.

In one example, the inductor current reference I_{Lref} may be optimized for CubeSats. For example, inductor current may vary between I_{Lmin} and I_{Lmax}. In some examples, the inductor current may have an average value that is equal to I_{Lref}. Further, a value of I_{Lmin} may be more than I_{mpp,max} in all operating conditions that can achieve a true MPPT for the CubeSat PV panels. Thus, a minimum feasible I_{Lref} can be calculated based on steady-state duty-cycle limits of the SCC and boost converter. This minimum feasible I_{Lref} can be used to reduce an amount of conduction losses.

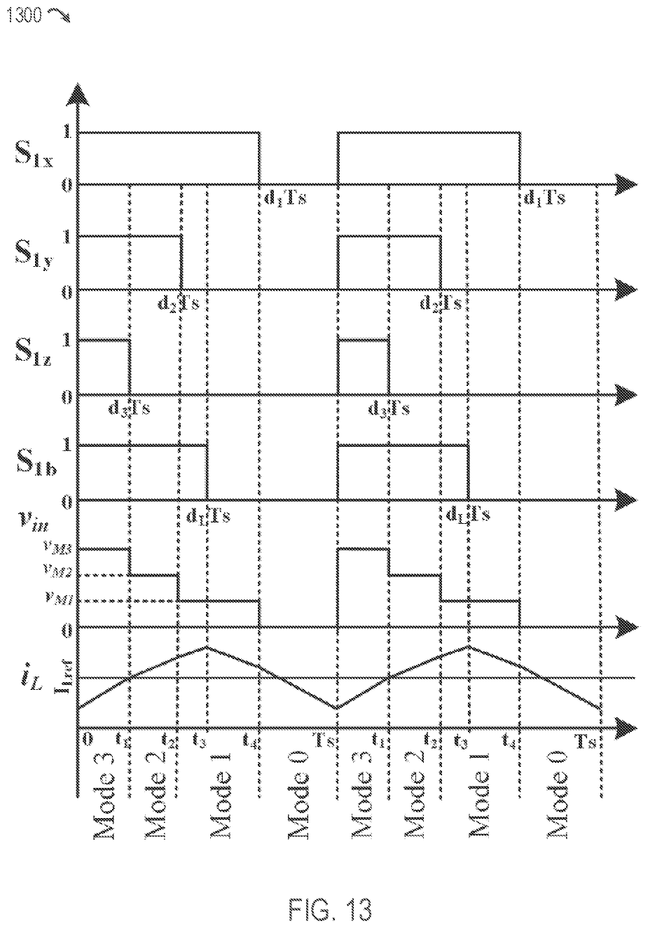

In some examples, a value of an inductor L may be calculated by limiting a peak current ripple to predetermined (e.g., desired) value. In such an example, the peak current ripple from may vary for different cases and sub-cases described herein. Further, an actual number of cases and sub-cases may depend on a MPP voltage, batter, voltage, and/or CubeSat PV panel irradiation conditions, etc. As described in greater detail below, with respect to FIG. 13, a procedure to calculate such a ripple is shown for four different cases.

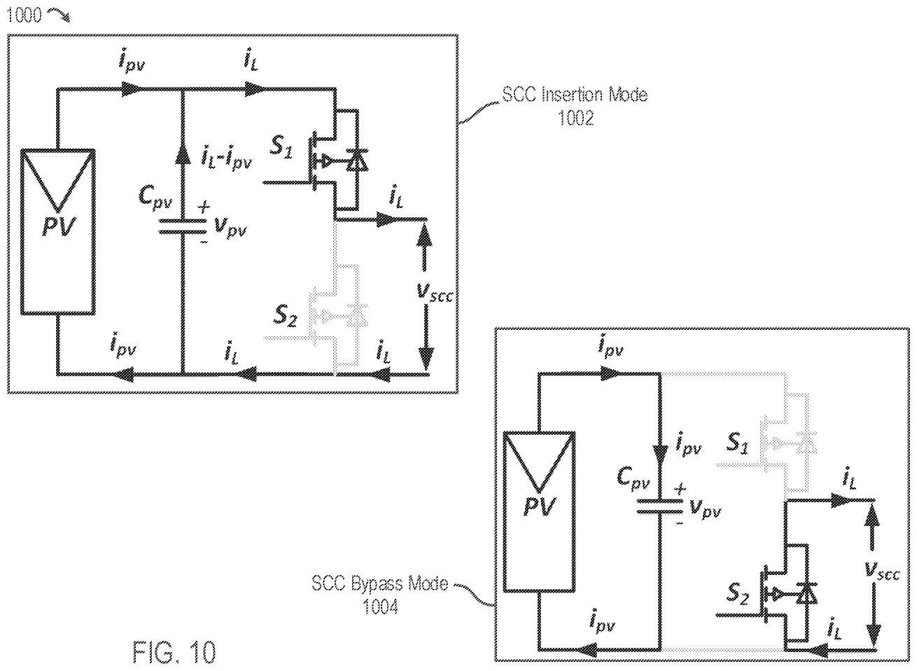

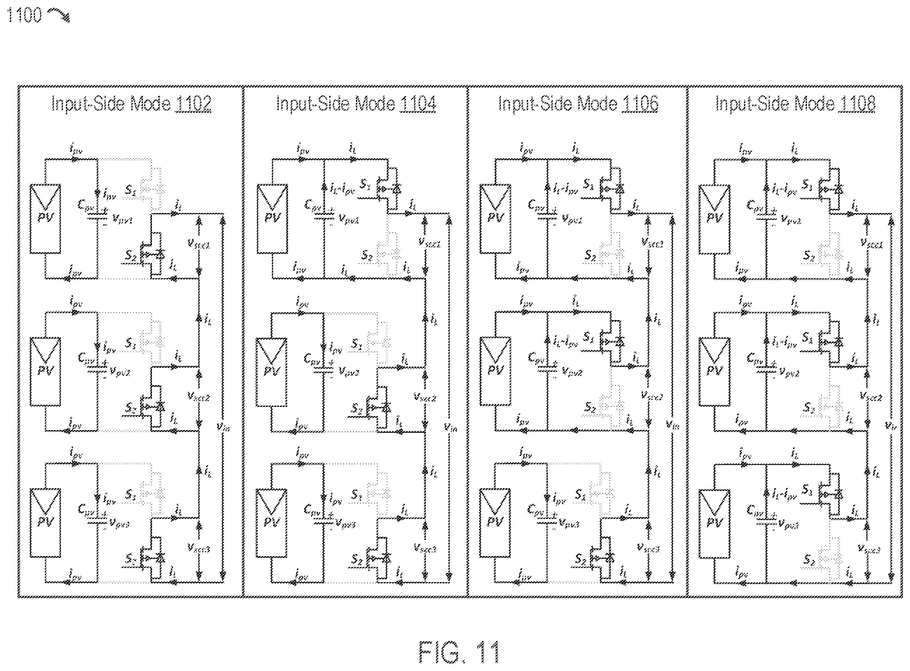

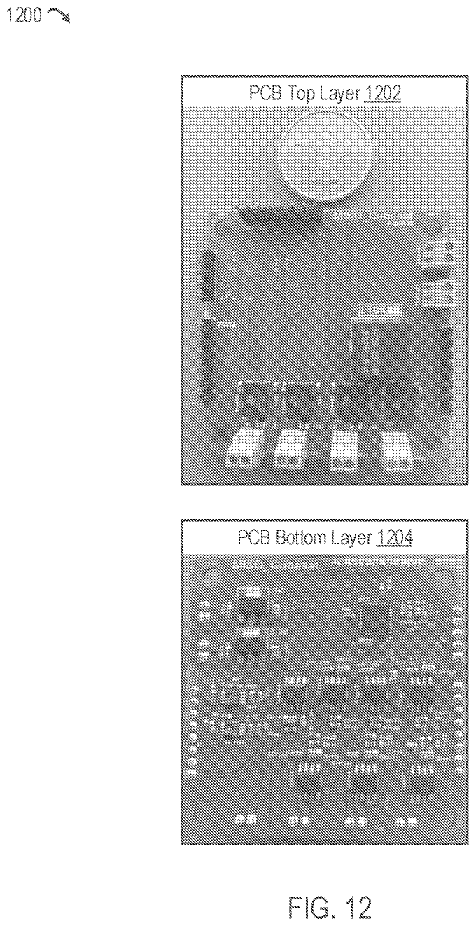

FIG. 10 depicts examples of modes of operation 1000 for a SCC of a multiport converter, in a CubeSat EPS, according to certain aspects of the present disclosure. Two exemplary modes of operation of a SCC are shown in FIG. 10. For example, the modes of operation 1000 may be used by a SCC shown in FIG. 9. In this example, the modes of operation 1000 include a SCC insertion mode 1002 and a SCC bypass mode 1004.

In one example, the modes of operation 1000 of an SCC include an amount of current i_{L} that is constant. In this example, the switches S₁ and S₂ operate in complimentary mode. So, when switch S₂ is ‘ON’, the SCC operates in SCC bypass mode 1004 wherein the PV panel current iₚᵥ charges Cₚᵥ and i_{L} flows via S₂. And when switch S₁ is ‘ON’, the SCC operates in SCC insertion mode 1002 wherein a net current of iₚᵥ−i_{L} flows via Cₚᵥ. To ensure charge balance for Cₚᵥ, i_{L} should be higher than the iₚᵥ at any time instance.

In the SCC bypass mode 1004, energy is transferred from CubeSat PV panels to a capacitor Cₚᵥ, whereas energy is transferred from the capacitor Cₚᵥ to an inductive element or one or more battery terminals in the SCC insertion mode 1002. In some examples, a duty cycle of each connected SCC may be controlled such that an amount of PV panel-generated voltage vₚᵥ is close to its MPP voltage Vₘₚₚ. Further, it should be appreciated that a value of SCC-generated voltage v_{scc} is amount of PV panel-generated voltage equal to vₚᵥ or zero depending on the whether S₁ is ‘ON’ or S₂ is ‘ON’, respectively.

FIG. 11 depicts additional examples of modes of operation for multiport converters in a CubeSat EPS, according to certain aspects of the present disclosure. Now, let us discuss the combined operation of all the SCCs. There exists four different modes of operation as demonstrated in FIG. 11, input-side mode 1102, input-side mode 1104, input-side mode 1106, and input-side mode 1108.

In this example, vₘ₀, vₘ₁, vₘ₂, and vₘ₃ denote the value of vᵢₙ during mode 0 (e.g., input-side mode 1102), mode 1 (e.g., input-side mode 1104), mode 2 (e.g., input-side mode 1106), and mode 3 (e.g., input-side mode 1108), respectively. In input-side mode 1102, vₘ₀ is equal to zero as all the SCCs are bypassed. In input-side mode 1104, only one of the SCCs is inserted and thus, vₘ₁ is equal to vₚᵥᵢ when i^{th} SCC is inserted. In input-side mode 1106, two of the SCCs are inserted and thus, vₘ₂ is equal to vₚᵥᵢ+vₚᵥⱼ, where i^{th} and j^{th} SCC are inserted. In input-side mode 1108, all the SCCs are inserted and thus, vₘ₃ is equal to Σᵢ₌₁³vₚᵥᵢ. Depending on the solar irradiation on the PV panels of CubeSat, some or all of these modes of operation may occur and the inserted SCCs in modes 1 and 2 will be different. There will be only input-side mode 1102 and input-side mode 1108 if all CubeSat PV panels have same solar irradiation.

The operation of a boost converter in the proposed topology is slightly different due to variable input voltage vᵢₙ. The reference value of i_{L} should be higher than MPP current at full irradiation or it can be dynamically changed to be higher than I_{mpp,max} based on the irradiation conditions. To achieve true MPPT for each panel, boost converter should operate such that iL remains higher than maximum MPP current of all the PV panels (I_{mpp,max}) under all irradiation conditions of CubeSat PV panels. The value of vᵢₙ depends on the duty cycle of SCCs (d₁ to d₃) which varies based irradiation conditions of CubeSat PV panels. The instantaneous value of vin may exceed the output voltage vₒ but the average value of vᵢₙ over a switching period should be less than vₒ for the converter to operate.

In some examples, inductor current i_{L} may rise when a switch S_{1b} is turned on, but the following cases may exist when the switch S_{1b} is turned off. For instance, the following cases may depend on an amount of voltage vₘₚₚ obtained from the CubeSat PV panels:
1) vₘ₃<v₀: i_{L} falls in all modes of operation.
2) vₘ₂<v₀<vₘ₃: i_{L} falls in modes 0,1,2 and rises in mode 3.
3) vₘ₁<v₀<vₘ₂: i_{L} falls in modes 0,1 and rises in modes 2,3.
4) v₀<vₘ₁: i_{L} falls in mode 0 and rises in modes 1,2,3.

And in some examples, different cases may exist that can influence the value of vᵢₙ based on irradiation conditions of the CubeSat. Four exemplary cases of these irradiation conditions are shown below.
1) Case 1: d_{L}≥dᵢ≥dⱼ≥dₖ.
2) Case 2: dᵢ≥d_{L}≥dⱼ≥dₖ.
3) Case 3: dᵢ≥dⱼ≥d_{L}≥dₖ.
4) Case 4: dᵢ≥dⱼ≥dₖ≥d_{L}.

Here, i, j, and k represents any one of the SCCs, and d_{L} represents the duty-cycle of the boost converter. Further, there exists further sub-cases based on which side of CubeSat panel receives higher irradiation. For example, there exists six sub-cases in case 2: (1) d₁≥d_{L}≥d₂≥d₃, (2) d₁≥d_{L}≥d₃≥d₂, (3) d₂≥d_{L}≥d₁≥d₃, (4) d₂≥d_{L}≥d₃≥d₁, (5) d₃≥d_{L}≥d₁≥d₂, and (6) d₃≥d_{L}≥d₂≥d₁.

In some examples, a multiport converter has been tested for several operating conditions to validate the performance levels described herein. For example, the multiport converter has been tested for operating conditions that include a steady-state performance level, a transient performance level, and for efficiency levels.

### Example Calculations for Gating Signals and Inductor Current Ripples

FIG. 13 depicts examples of gating signals 1300 for a multiport SCC and a boost converter for a CubeSat EPS, according to certain aspects of the present disclosure. In this example, the gating signals 1300 for the SCC and boost converter are represented by the input voltage vᵢₙ and current i_{L} for a case where d₁>d_{L}>d₂>d₃.

The gating signals 1300 shown in FIG. 13 illustrates an operation of a boost converter for an exemplary case, where d₁≥d_{L}≥d₂≥d₃. In this case, vᵢₙ has four discrete voltage levels (vₘ₀ to vₘ₃) in each switching period and thus, rising and falling slopes of t_{L} varies in different intervals. For example, the rising slope of i_{L} during intervals 0 to t₁ and t₁ to t₂ is equal to

$$\frac{{v}_{m 3}}{L} and \frac{{v}_{m 2}}{L} ,$$

respectively. Similarly, the falling slope of i_{L} during intervals t₃ to t₄ and t₄ to Tₛ is equal to

$$\frac{{v}_{0} - {v}_{m 1}}{L} and \frac{{v}_{0}}{L} ,$$

respectively. Here, we have considered that v₀>vₘ₁ based on IU CubeSat requirements.

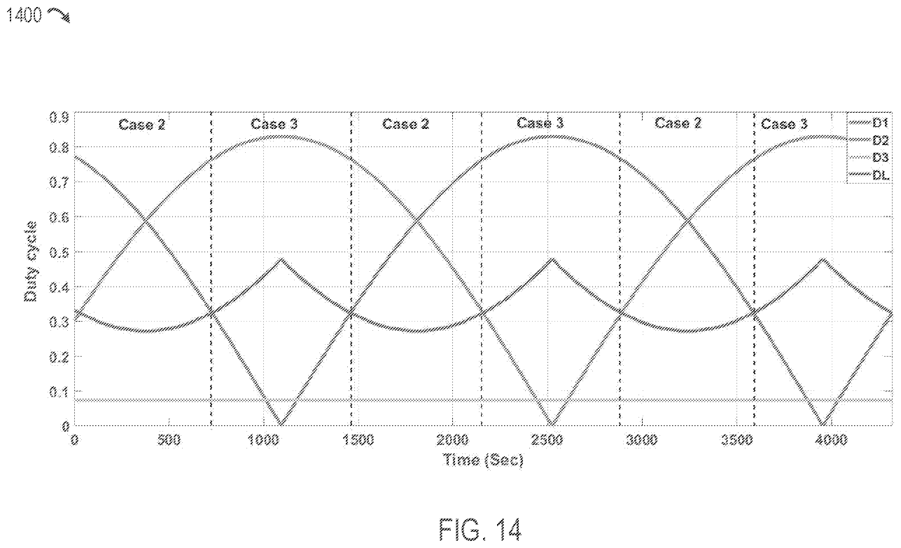

FIG. 14 depicts examples of estimated duty-cycles 1400 of a multiport SCC and a multiport boost converter for an IU CubeSat in a full orbit, according to certain aspects of the present disclosure. In this example, I_{L} remained fixed at a value of Iₘₚₚ^{s}. It should also be appreciated that only two out of four cases described above, with respect to FIGS. 9-11, are shown for irradiation conditions experienced by the CubeSat.

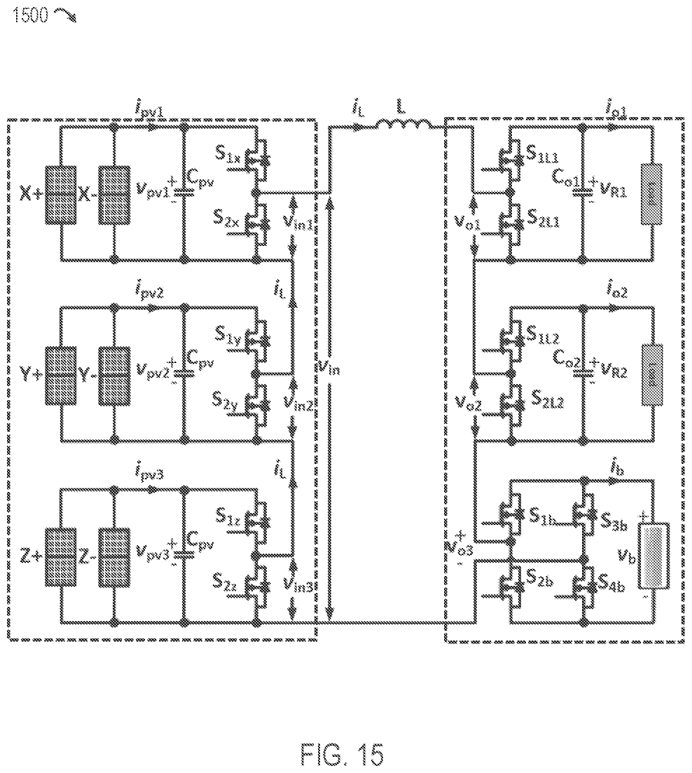

FIG. 15 depicts yet another example of a multiport converter topology 1500 for a CubeSat EPS, according to certain aspects of the present disclosure. The multiport converter topology 1500 depicted in FIG. 15 includes a MIMO converter. In this example, the multiport converter topology 1500 includes a generation side, which has PV panels shown on opposite sides (e.g., opposing PV panels X+ and X−, Y+ and Y−, and Z+ and Z−). These PV panels are connected in parallel to a capacitor and to a HB module. Each HB module includes a first switch (e.g., S₁ₓ, S_{1y}, or S_{1z}) and a second switch (e.g., S₂ₓ, S_{1y}, or S_{2z}). The outputs of the HB modules are connected in series and are fed to loads and battery terminals via the inductor.

The multiport converter topology 1500 includes a load-side, which has HB modules that may be used to supply regulated voltages (e.g., V_{R1}, V_{R2}, and V_{b}) to load equipment and the battery. In this example, the HB modules are connected via a full-bridge (FB) module. The inputs of both the HB modules and FB modules are connected in series. The top and bottom switches of the HB modules and FB modules operate in complimentary mode. The HB module operates in either a bypass mode or an insertion mode, for example, depending on whether the top switch is turned on or is turned off, respectively.

In some examples, the FB module may be controlled to track a reference value for i_{L}. Further, the reference value for an amount of inductor current it may be maintained at a higher amount of current than a maximum amount of PV panel current. In one example, the battery may be charged or discharged when both serially-connected switches S_{1b} and S_{2b} are turned on or off, respectively. On the generation-side, the capacitor Cₚᵥ may be charged by the PV panel current iₚᵥ during a bypass mode. And the capacitor Cₚᵥ may be discharged by a net current that is reflected by an amount of inductor current i_{L} minus an amount of PV panel current iₚᵥ during an insertion mode.

In some examples, a duty cycle of a generation-side HB module may also be controlled. For instance, the generation-side HB modules can be controlled such that a maximum amount of available power is withdrawn. In one example, the duty cycles of the generation-side HB modules can be optimized to ensure the maximum amount of power is withdrawn from all of the PV panels. Further, the duty cycles of the generation-side HB modules can be optimized to ensure the maximum amount of power is withdrawn by inductor current within each cycle. In other examples, the duty-cycle of load-side I-B modules may also be controlled. In some examples, the duty-cycle of load-side HB modules may be controlled such that an amount of inductor current i_{L}, is configured to supply a load demand (e.g., an amount of power required by a load) such that an output voltage may be regulated at desired value (e.g., at 3.3 volts (V), 5 V, etc.).

Examples of a Periodic and Ground Station Controlled Reset

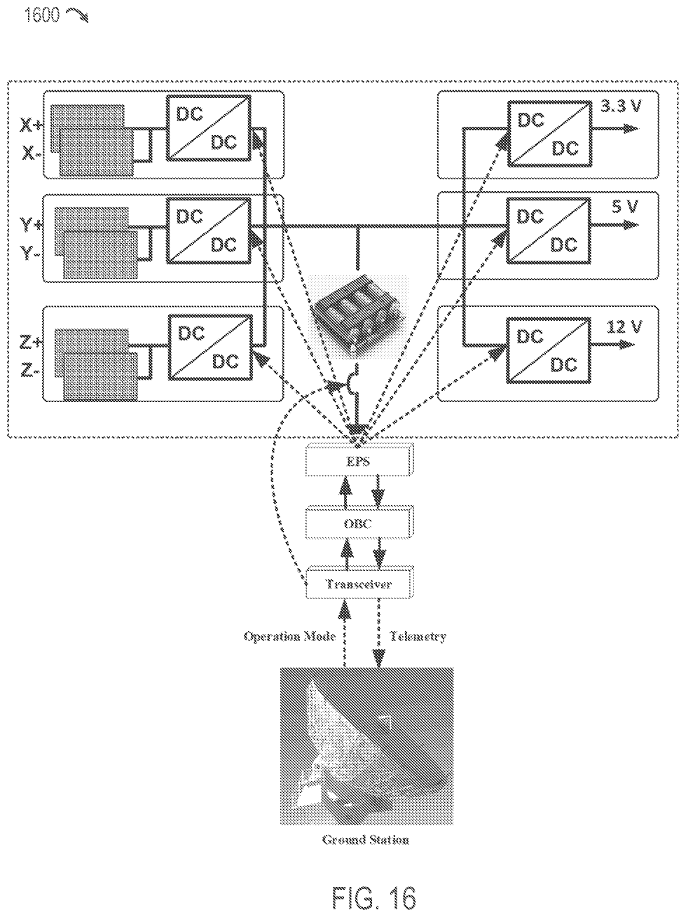

FIG. 16 depicts another example of an EPS architecture 1600 for a CubeSat EPS, according to certain aspects of the present disclosure. In this example, to monitor CubeSat operations, telemetry data for various measurements (e.g., sensor data) may be transmitted to ground station shown in FIG. 16. The sensor data can be analyzed to determine a state of the CubeSat (e.g., an overall health and/or operating mode). During these critical scenarios, a power-down operation can be commanded from the ground station to switch-off the power converters until the CubeSat operation has been restored. Advantageously, remote power-down operations may simplify an amount of troubleshooting that is required by the CubeSat during anomalous periods.

In one example, the sensor data may indicate an on-orbit anomaly In the case of an on-orbit anomaly, such as a single-event upset, a ground station team may need to debug the CubeSat. For instance, the ground station team may need to debug the CubeSat's system data and/or take measures to recover the CubeSat system's functionality. The ground station may do so by sending one or more command signals to reset the satellite and/or change an operating mode of the satellite. As a result, the grounds station can utilize command signals to minimize an impact of a failure. In some examples, a command signal or a control signal may be sent directly from the transceiver to a switch for the battery.

In some examples, a commercial EPS may implement a periodic reset of power on the entire CubeSat based on a watchdog timers. Further, the CubeSat may experience a situation where both the MCU and OBC are in hanging mode, which makes it difficult to do periodic reset or forced reset from the ground station. To avoid these issues, the patent proposes to use hard reset of entire CubeSat by using analog time switch in series with the battery. This analog switch opens periodically for short time to remove the power to entire CubeSat and also, this can be controlled from the signal coming from ground station directly via the transceiver (bypasses both OBC and MCU). This proposed strategy simplifies the troubleshooting during anomalies periods.

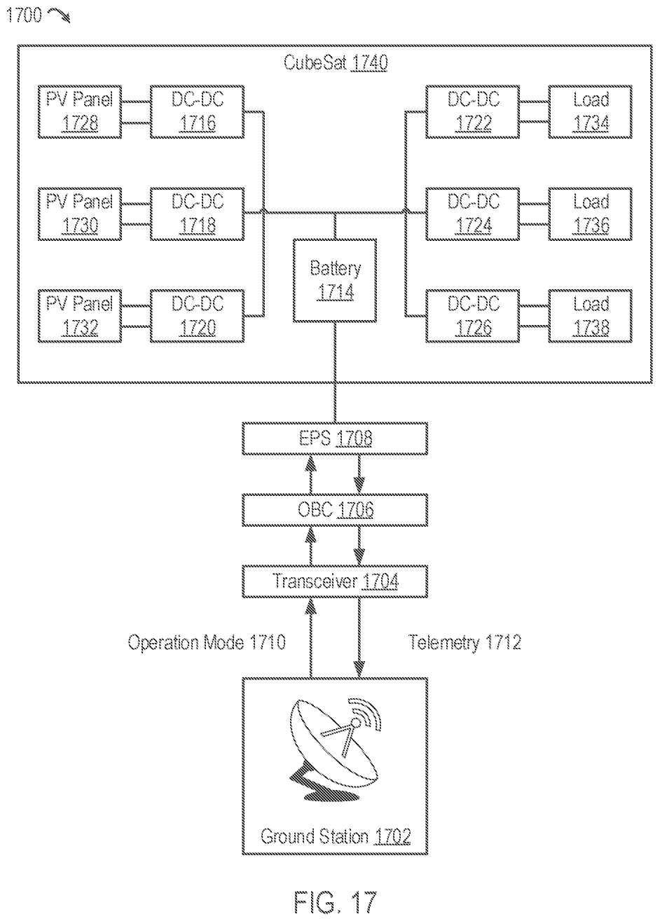

FIG. 17 depicts yet another example of an EPS architecture 1700 for a CubeSat EPS, according to certain aspects of the present disclosure. The EPS architecture 1700 may include substantially similar capabilities to the EPS architecture 1600 described above. For example, the EPS architecture 1700 includes output voltage levels and a DC bus voltage for a IU or a 2U CubeSat 1740. The CubeSat 1740 is in communication with a ground station 1702, for example, via a transceiver 1704 and an OBC 1706. The CubeSat 1740 can receive command signals from the ground station 1702, such as an operation mode 1710 and/or telemetry information 1712. But in this example, the EPS architecture 1700 includes a separate EPS system 1708.

In this example, the EPS system 1708 may be able to control the power systems for the CubeSat 1740. For instance, the EPS system 1708 can control operating conditions for one or more components of the CubeSat 1740, which includes PV panels 1728, 1730, 1732, which are coupled to DC-to-DC converters 1716, 1718, and 1720, respectively. The output of DC-to-DC converters 2416-2420 is sent over a common DC bus, which is also coupled to battery 1714. The CubeSat 1740 includes load-side DC-to-DC converters 1722, 1724, 1726 that supplies load demand power to loads 1734, 1736, and 1738, respectively.

### Example Power-downs of Load-side Converters

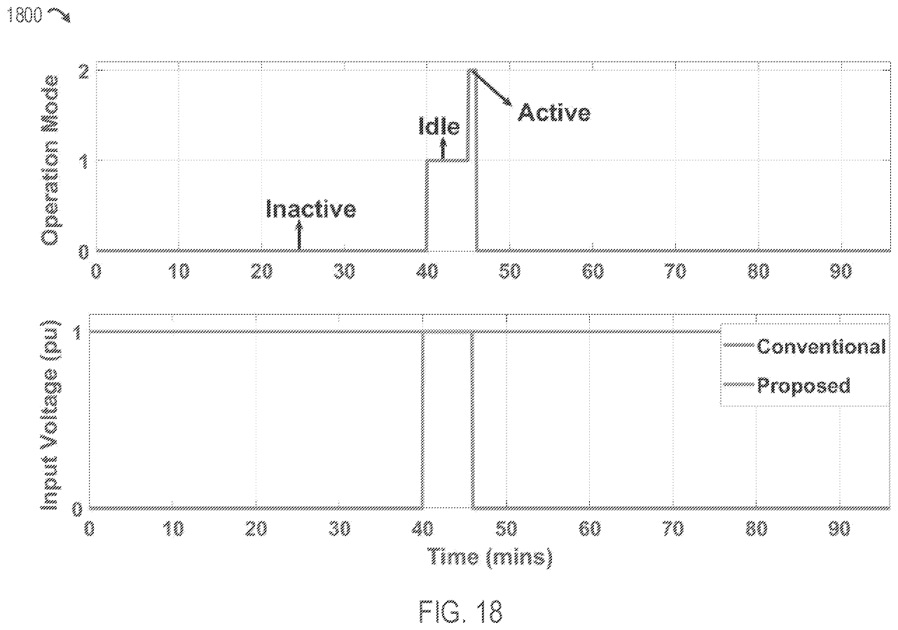

FIG. 18 depicts an example of an operating mode using an input voltage of a camera in an imaging mode orbit 1800, according to certain aspects of the present disclosure. In this example, load-side converters provide regulated output voltages to payloads. In some examples, the power-down mode may be implemented based on a predicted power generation profile and/or a load consumption profile. Further, the power generation profiles and/or a load consumption profiles in CubeSats may be determined based on the mission objectives. Therefore, a new mode of operation termed as power-down mode is proposed to reduce the electrical and thermal stresses on the power converters and thus, improving the overall system reliability. The function of power-down mode is to switch-off semiconductor devices during low power or no-load condition. The power-down mode may be applied to MPPT converters (e.g., power generation-side converters) and load-side converters.

The CubeSat may be pre-programmed to perform certain tasks during each orbit. For example, the CubeSat may be scheduled to perform a task such as pointing the camera in one orbit, or imaging in another orbit, etc. Thus, the power-down mode for load-side converters (e.g., one or more redundant buck converters) can be easily activated based on the pre-programmed operating modes. For instance, depending on the mission objectives, a CubeSat may be pre-programmed to perform certain tasks at different points of time. Thus, a power-down mode for such load-side converters can be easily activated based on one or more pre-programmed operating modes.

In one example, a CubeSat may include a camera (e.g., camera 310), which acts as a payload that is powered by a dedicated converter. In this example, non-imaging orbits are already fixed, and a power-down mode is made active in the fixed non-imaging orbits. The activation of the power-down mode switches semiconductor devices used in these non-imaging orbits off. In some examples, the camera is operational only for a fractional time. For example, the camera mat operate for part of the time, even when the CubeSat is in an imaging mode.

Further, FIG. 18 illustrates one such example of an operational status 1800 of the camera In this example, an operation mode of ‘0’ corresponds to an inactive mode, an operation mode of ‘1’ corresponds to an idle mode, and an operation mode of ‘2’ corresponds to an active mode. In LEO, the camera may begin preparation for the imaging mode approximately 5 minutes before taking an image. This period of preparation is one example of an idle mode ‘1.’ Next, the process of taking an image may include a duration of approximately 1 minute and is an example of an active mode ‘2.’ And in this example, a power-down mode may be deactivated during the idle mode and the active mode of the camera in the imaging mode during the LEO.

Thus, the power-down mode can be deactivated during the orbit to provide a regulated output voltage to the camera. Without this power-down mode operation, the multiport converter would provide the regulated voltage during the entire orbit, even under a no-load operation. Advantageously, the power-down mode described herein may ensure that semiconductor devices in the camera are switched-on for 6 minutes out of 96 minutes cycle. In other words, the power-down mode of the camera and its devices are completely switched-off, thereby significantly reducing operational stresses on the semiconductor devices, during both imaging orbit and non-imaging orbits.

### Examples of Power-down of Generation-side Converters

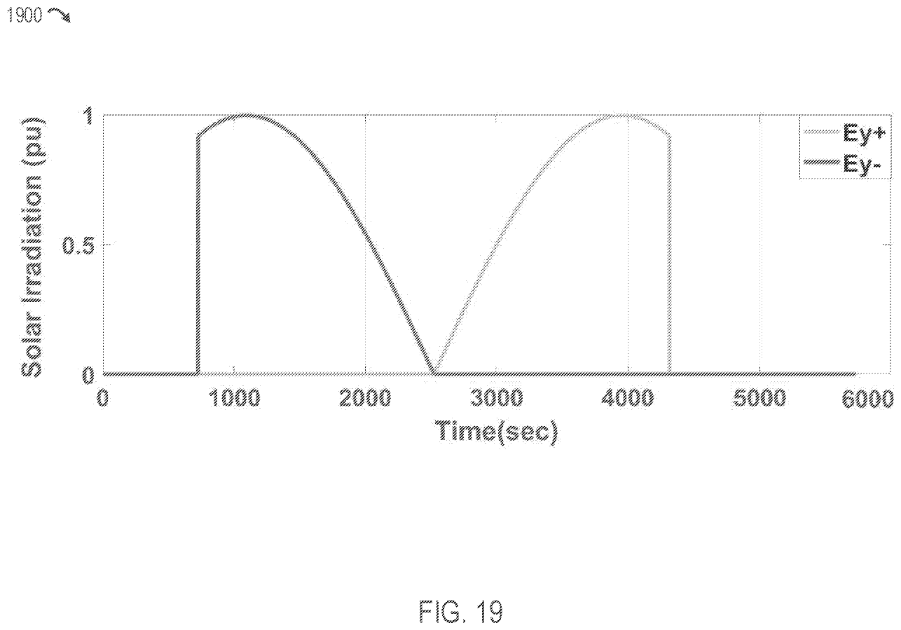

FIG. 19 depicts examples of simulation results 1900 for solar irradiation on facets of a CubeSat in orbit, according to certain aspects of the present disclosure. In some examples, simulations may be performed by program code for software, such as a General Mission Analysis Tool (GMAT) or MATLAB. As the CubeSat revolves in the orbit, each facet gets variable solar irradiation due to changes in a beta angle and zero solar irradiance during eclipse period. In some examples, the CubeSat includes body mounted PV panels. In such a case, only one of the opposite facets may receive solar irradiation at any point of time. Thus, an effective amount of solar irradiation may be obtained using a simulation that can detect solar irradiation on PV panels mounted to CubeSat facets. In one example, the simulation detects the effective amount of solar irradiation received by PV panels mounted to CubeSat facets having Y+ and Y− relative directionalities.

FIG. 19 illustrates such simulation results 1900 for the solar irradiation that is received from PV panels mounted on CubeSat facets Y+ and Y−. In this example, each facet may only receive solar irradiation for brief durations of time during the orbit of the CubeSat. Thus, generation-side converters of the CubeSat need not be operated continuously throughout. In some examples, the generation-side power converters activate the power-down mode when there is no solar irradiation detected, which reduces operational stresses of semiconductor devices in the CubeSat. In some examples, the CubeSat may continuously monitor solar irradiation on its PV panels to ensure the power-down mode is selectively activated for MPPT converters In this example, the power-down mode for MPPT converters is made possible based on an independence of the MPPT converters In contrast to conventional systems, the redundant MPPT converter described herein may be powered down, whereas conventional converters need to operate continuously in a sunlit period (e.g., as one of the two panels on opposing facets almost always receives irradiation).

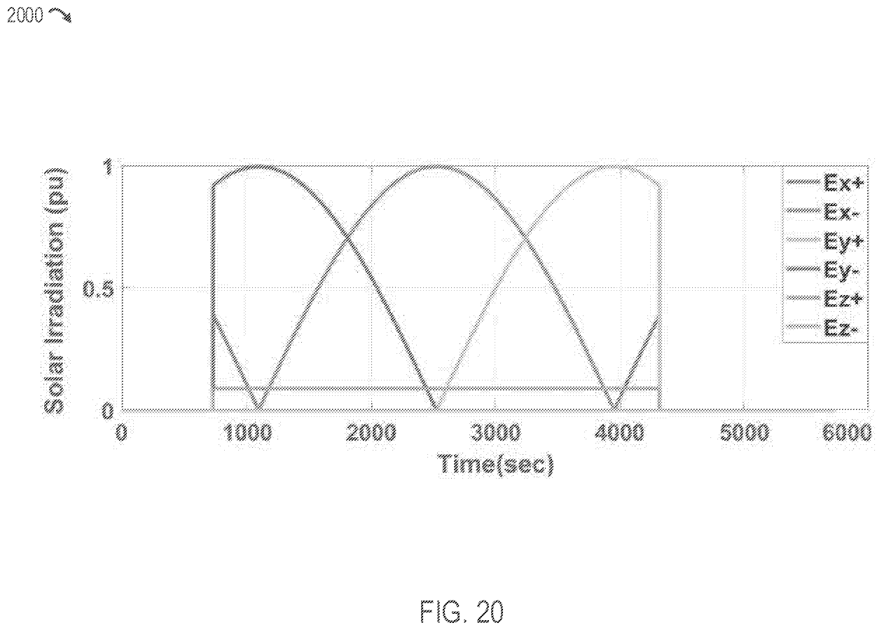

FIG. 20 depicts examples of simulation results 2000 for solar irradiation on each facet of a CubeSat in orbit, according to certain aspects of the present disclosure. In this example, an amount of solar irradiation received on each facet of a CubeSat (e.g., CubeSat 300) are varied. The simulation results 2000 exclude an eclipse period observed by the CubeSat that lasted for a duration of 6 s (e.g., for clarity in the illustration). During low irradiation and/or an eclipse period, the gating signals to semiconductor devices may be turned off to reduce the thermal and electrical stresses.

The CubeSat includes the following operating modes (i) a safe mode and (ii) a normal mode. The safe mode includes a minimal amount of power consumption to charge the battery. In the normal mode, an amount of power consumption may depend on a task performed because each task may include a different load demand. For instance, tasks may include taking an image, pointing, and/or downloading data.

Taking an image mat include functions such as camera-active or camera-idle.

Pointing functions may include, for example, activating or deactivating an attitude determination and control system (e.g., ADCS-active or ADCS-idle). Similarly, downloading functions may include sending and receiving data that is abbreviated as communication transmissions (e.g., COM TX or COM RX, respectively). With these parameters, an EPS may be developed in simulations for validation.

In one example, the simulation results 2000 may be validated. For example, to validate proposed concepts, an EPS model may be designed based on data from MySat-1. In this example, the data from the MySat-1 is based on a IU CubeSat developed by Khalifa University. Further, each facet of the tested CubeSat includes two Azurspace PV cells connected in series. The parameters of these PV cells that were tested at 1367 w/m² and 28° C. are as follows: an OC voltage (V_{oc})=2.7 V, SC current (I_{sc})=520 A. MPP voltage (Vₘₚₚ)=2.411 V, and MPP current (Iₘₚₚ)=0.504 A.

In this example, the CubeSat may be assumed to be operating in a LEO orbit having a height of 450 km with inclination angle of 51.6°. Further, a total orbital period may be equal to 96 minutes. And in this example, an eclipse occurs between 0 to 726 s and between 4327 s and 5760 s. The amount of solar irradiation on each of the six facets of the CubeSat obtained using simulation results 2000 are shown in FIG. 20.

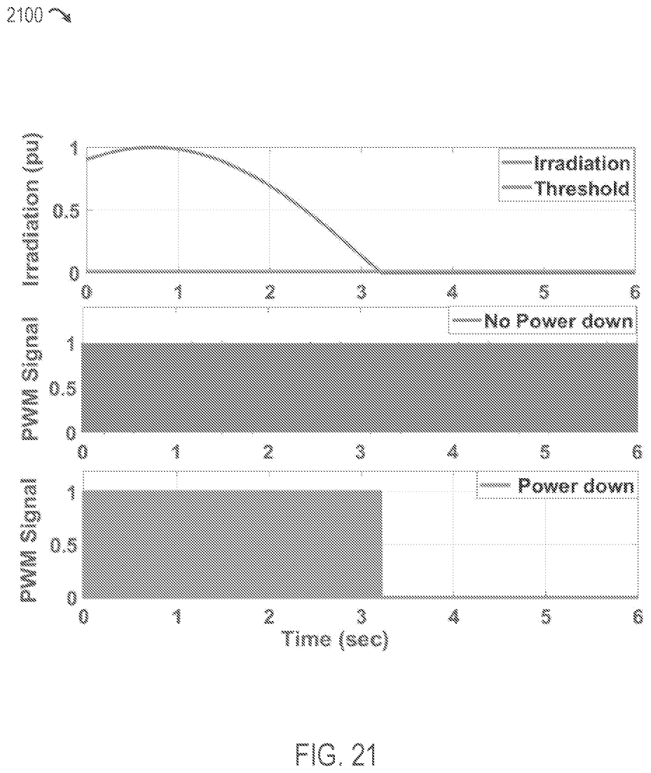

FIG. 21 depicts examples of simulation results 2100 for solar irradiation and gating signals of a redundant MPPT converter on a particular facet of a CubeSat in orbit, according to certain aspects of the present disclosure. In this example, an amount of solar irradiation received on each facet of a CubeSat (e.g., CubeSat 300) are varied. The simulation results 2100 exclude an eclipse period observed by the CubeSat that lasted for a duration of 6 s. The simulation results 2100 illustrate one example of the power-down concept. For instance, during a low irradiation and/or eclipse period, the gating signals to semiconductor devices are turned off to reduce the thermal and electrical stresses.

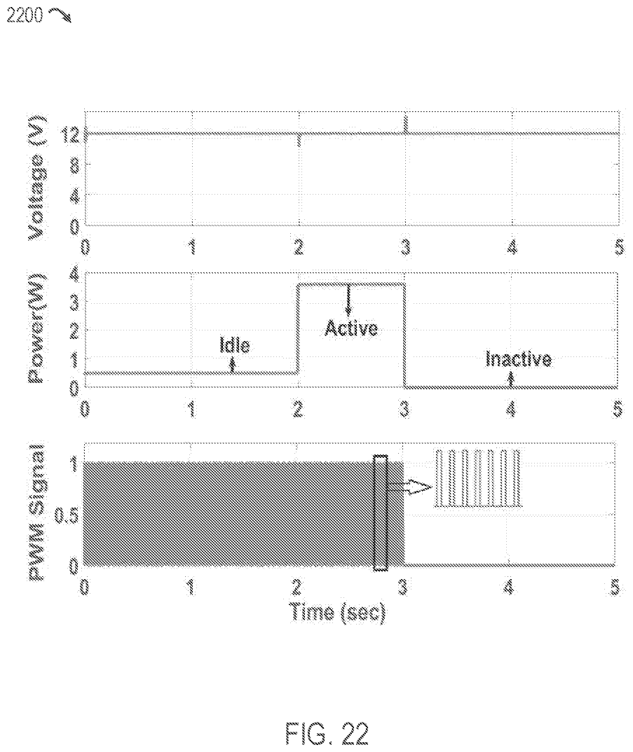

FIG. 22 depicts another example of simulation results 2200 for a load-side boost converter in a CubeSat EPS, according to certain aspects of the present disclosure. In this example, a CubeSat may be considered to be operating in a “normal” mode when executing one or more of the following functions: pointing, taking an image, and downloading data. The simulation results 2200 include an output voltage, current, and power of a load-side 12 V voltage regulator.

When considered together, the simulation results 2200 further demonstrates that controller is able to supply the various load demands while regulating the output voltage at a fixed reference value. Further, a power-down mode is illustrated for the 12 V converter shown in FIG. 22. And in this example, the gating signal to a semiconductor device can be removed during a no-load operation.

### Example Processes for Power-down Modes in CubeSats

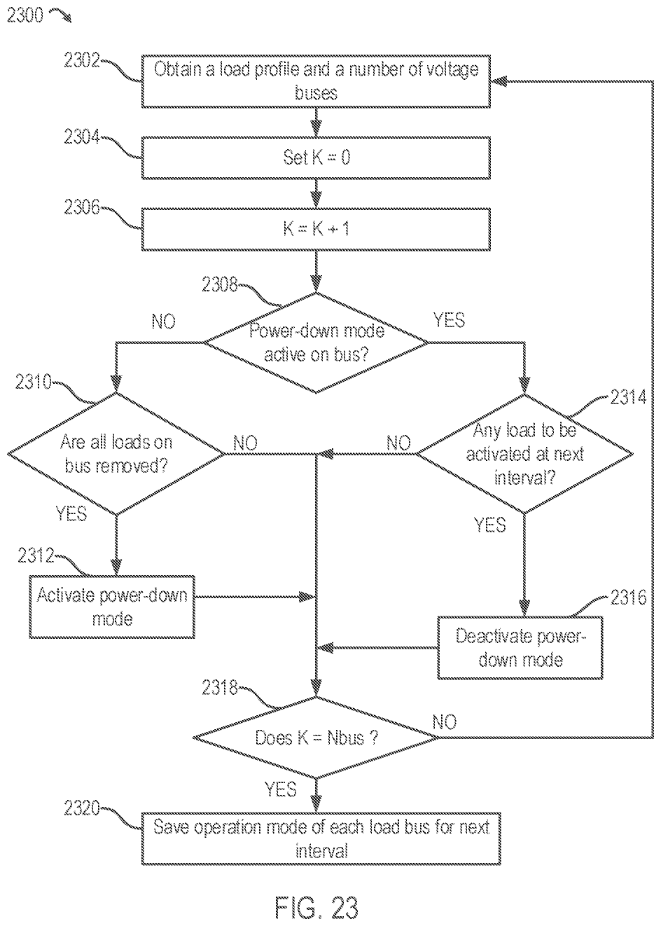

FIG. 23 illustrates an example of a flow-chart for a process 2300 that involves a power-down mode for load-side converters, according to certain aspects of the present disclosure. One or more operations described with respect to FIG. 23 are used to implement power-down mode for load-side converters. In some aspects, one or more computing devices implement operations depicted in FIG. 23 by executing suitable program code. For illustrative purposes, the process 2300 is described with reference to certain examples depicted in the figures. Other implementations, however, are possible.

In this example, K represents one of the PV panels and Nₚᵥ represents the total number of PV panels. This algorithm will be executed at predefined time interval. For each PV panel, power-down mode is activated when the panel current is approximately equals to zero. This can happen both in eclipse period and in sunlit period. When the panel operates in power-down mode, the panel current on the opposite-side of the CubeSat is tracked to see if it becomes zero. The panel power-down mode is stopped when the opposite panel enters power-down mode. This is based on the principle that only one of the opposite-side panels of CubeSat receive irradiation at any point of time.

At block 2302, the CubeSat 300 obtains a load profile and a number of voltage buses. At block 2304, the CubeSat 300 sets a value of K equal to zero. At block 2306, the CubeSat 300 increments the value of K by one. Block 2308 is a decision block, where the CubeSat 300 determines whether a power-down mode is active on the bus. If the power-down mode is not active, the process 2300 continues down a “NO” branch to block 2310. Alternatively, if the power-down mode is active on the bus, the process 2300 continues down a “YES” branch to block 2314.

Block 2310 is another decision block. At decision block 2310, the CubeSat 300 determines whether all loads on the bus is removed, in response to determining the power-down mode is not active at block 2308. In response to a determination that all loads on the bus is removed, the process 2300 continues down a “YES” branch to block 2312. Alternatively, if all of the loads on the bus have not been removed, the process 2300 continues down a “NO” branch to block 2318. At block 2312, the CubeSat 300 activates the power-down mode.

Block 2314 is another decision block. At block 2314, the CubeSat 300 determines whether any load is to be activated at a next interval. In response to a determination that load is to be activated at the next interval, the process 2300 continues down a “YES” branch to block 2316. Alternatively, if there is no load that is to be activated at the next interval, then the process 2300 continues down a “NO” branch to block 2318. At block 2316, the CubeSat 300 deactivates the power-down mode. In one example, a power-down mode may be deactivated during the idle mode and the active mode of the camera in the imaging mode during the LEO. Thus, the power-down mode can be deactivated during the LEO to provide a regulated output voltage to the camera. Without this power-down mode operation, the multiport converter would provide the regulated voltage during the entire orbit, even under a no-load operation, as described above with respect to FIG. 18.

Block 2318 is yet another decision block. At block 2318, the CubeSat 300 determines whether the value of K is equal to N_{bus}. If the value of K is equal to N_{bus}, the process 2300 continues down a “YES” branch to block 3620. Alternatively, if the value of K is not equal to N_{bus}, the process 2300 returns to block 2302 via a “NO” branch. At block 3620, the CubeSat 300 enters a save operation mode of each load bus for the next interval. In this example, the CubeSat 300 performs a save operation for each load bus for the next interval based on the determination that the value of K is equal to N_{bus} from block 2318.

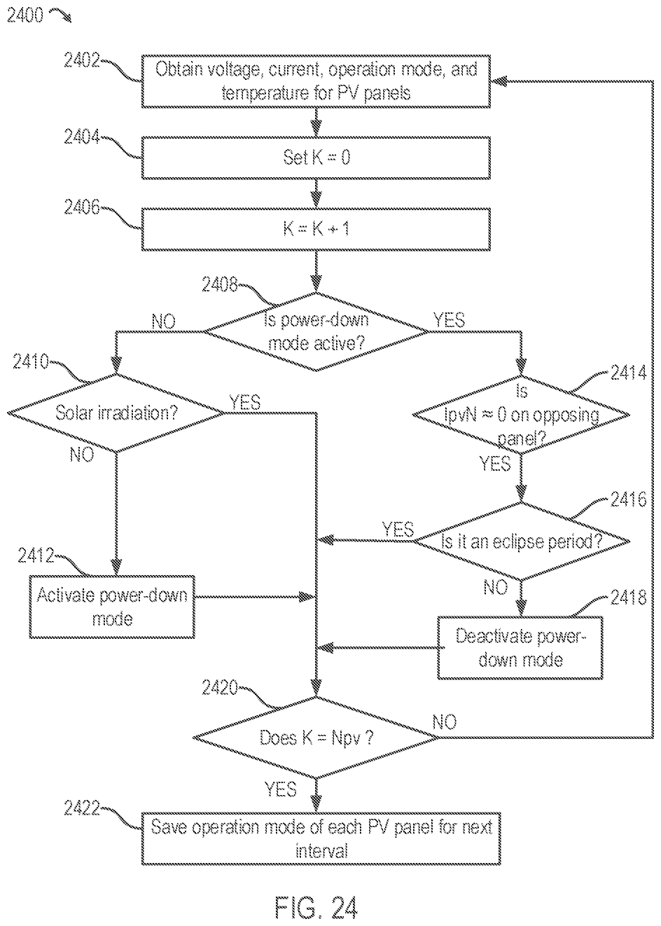

FIG. 24 illustrates an example of a flow-chart for a process 2400 that involves a power-down mode for generation-side converters, according to certain aspects of the present disclosure. One or more operations described with respect to FIG. 24 are used to implement power-down mode for load-side converters. In some aspects, one or more computing devices implement operations depicted in FIG. 24 by executing suitable program code. For illustrative purposes, the process 2400 is described with reference to certain examples depicted in the figures. Other implementations, however, are possible.

Some existing solutions use component overrating and redundant design to improve the reliability of satellite EPS. Further, some converters use frequency switching to reduce to improve system efficiencies, for example, during either no-load or light load conditions. Thus, a similar technique can be utilized for satellite EPS systems to reduce operational stress of semiconductor devices. For instance, multiple parallel converters between input and output are proposed to achieve efficient operation over wide range, which leads to control complexity and additional components. In other examples, energy storage circuits along with dedicated controllers are proposed to identify the light/no-load operation to improve the system efficiency. Some literature proposed utilization of low dropout regulator (LDO) along with a DC-to-DC converter to improve the system operation at light load operation, for example, bypassing the DC-to-DC converter and using the LDO regulator at light load operation. However, the introduction of such additional components which is not preferable in satellite EPS due to reliability issues.

In this example, at block 2402, a CubeSat 300 obtains a voltage, a current, an operation mode, and a temperature for PV panels. At block 2404, the CubeSat 300 sets a value of K equal to zero. At block 2406, the CubeSat 300 increments the value of K by one. Block 2408 is a decision block, where the CubeSat 300 determines whether a power-down mode is active. Block 2410 is another decision block. At block 2410, the CubeSat 300 determines whether there is solar irradiation on a PV panel. At block 2412, the CubeSat 300 activates the power-down mode.

Block 2414 is another decision block. At block 2414, the CubeSat 300 determines whether a value of the PV panel current I_{pvN} from an opposing panel is approximately equal to zero. Block 2416 is yet another decision block. At block 2416, the CubeSat 300 determines whether the current time period is during an eclipse period. At block 2418, the CubeSat 300 deactivates the power-down mode. Block 2420 is a second decision block, where the CubeSat 300. At block 2422, the CubeSat 300 enters a save operation mode of each PV panel for the next interval. In this example, the CubeSat 300 performs a save operation for each load bus for the next interval based on the determination that the value of K is equal to Nₚᵥ from block 2420.

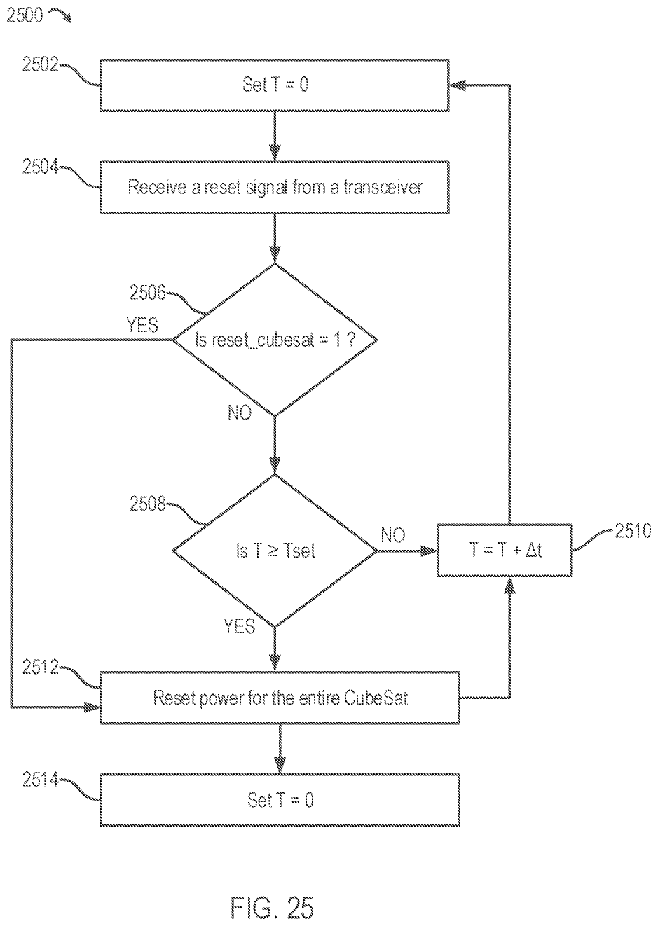

FIG. 25 illustrates an example of a flow-chart for a process 2500 that involves a periodic and ground controlled CubeSat reset, according to certain aspects of the present disclosure. One or more operations described with respect to FIG. 25 are used to implement power-down mode for load-side converters. In some aspects, one or more computing devices implement operations depicted in FIG. 25 by executing suitable program code. For illustrative purposes, the process 2500 is described with reference to certain examples depicted in the figures. Other implementations, however, are possible.

At block 2502, the CubeSat 300 sets a timer T equal to zero. At block 2504, the CubeSat 300 receives a reset signal from a transceiver. Block 2506 is a decision block, where the CubeSat 300 determines whether a value of reset_cubesat is equal to 1. Block 2508 is a second decision block, where the CubeSat 300 determines whether a value of the timer T is greater than or equal to a predetermined timer value of Tₛₑₜ. At block 2510, the CubeSat 300 determines the value of the timer T is equal to T plus a change in time Δt. At block 2512, the CubeSat 300 resets the power for the entire CubeSat 300. At block 2514, the CubeSat 300 sets the timer T equal to zero.

### Example Computing Systems for Implementing Certain Aspects

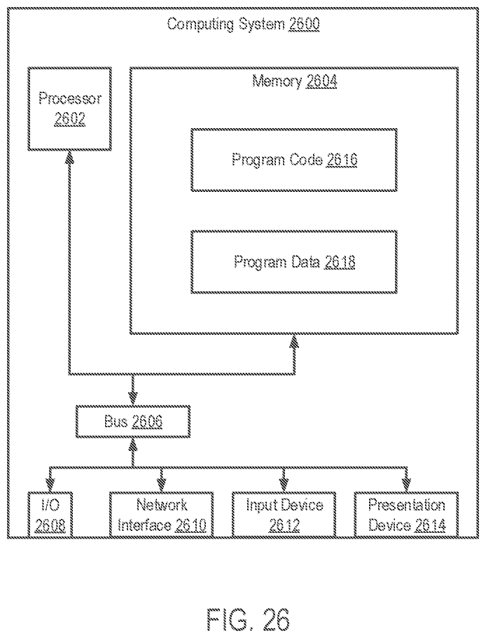

Any suitable computing system can be used for performing the operations of the present disclosure. FIG. 26 depicts an example of a computing system 2600 that performs certain operations described herein, according to certain aspects of this disclosure. In some aspects, the computing system 2600 executes program code for the CubeSat EPS. In other aspects, separate computing systems having devices similar to those depicted in FIG. 26 (e.g., a processor, a memory, etc.) separately execute parts of the CubeSat EPS.

The example of a computing system 2600 includes a processor 2602 communicatively coupled to one or more memory devices 2604. The processor 2602 executes computer-executable program code 2616 stored in memory device 2604, accesses information (e.g., program data 2618) stored in memory device 2604, or both. Examples of processor 2602 include a microprocessor, an application-specific integrated circuit (ASIC), a field-programmable gate array (FPGA), or any other suitable processing device. Processor 2602 includes any number of processing devices, including a single processing device.

The memory device 2604 includes any suitable non-transitory computer-readable medium for storing data, program code, or both. A computer-readable medium includes any electronic, optical, magnetic, or other storage device capable of providing a processor with computer-readable instructions or other program code. Non-limiting examples of a computer-readable medium include a magnetic disk, a memory chip, a ROM, a RAM, an ASIC, optical storage, magnetic tape or other magnetic storage, or any other medium from which a processing device that reads instructions. The instructions includes processor-specific instructions generated by a compiler or an interpreter from code written in any suitable computer-programming language, including, for example, C, C++, C#, Visual Basic, Java, Python, Perl, JavaScript, and ActionScript.

The computing system 2600 also includes a number of external or internal devices, such as input or output devices. For example, the computing system 2600 is shown with one or more input/output (I/O) interfaces 2608. An I/O interface 2608 receives input from input devices (e.g., input device 2612) or provide output to output devices. One or more buses 2606 are also included in the computing system 2600. The bus 2606 communicatively couples one or more components of a respective one of the computing system 2600.

The computing system 2600 executes program code 2616 that configures the processor 2602 to perform one or more operations of the present disclosure. For example, the program code 2616 includes suitable applications to perform operations described herein. The program code 2616 resides in the memory device 2604 or any suitable computer-readable medium that is executable by the processor 2602 or another suitable processor. In additional or alternative aspects, the program code 2616 described above is stored in one or more other memory devices accessible via a data network.

The computing system 2600 also includes a network interface device 2610. The network interface device 2610 includes any device or group of devices suitable for establishing a wired or wireless data connection to one or more data networks. Non-limiting examples of the network interface device 2610 include an Ethernet network adapter, a modem, and/or the like. The computing system 2600 is able to communicate with one or more other computing devices via a data network using the network interface device 2610.

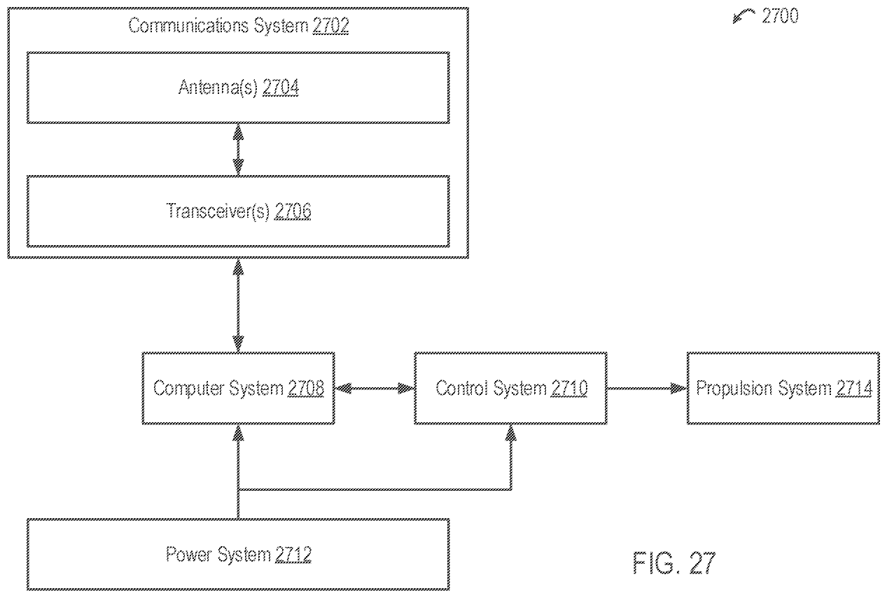

FIG. 27 illustrates another example of components of a CubeSat system 2700, according to certain aspects of the present disclosure. The satellite can be any of the satellites described herein above. As illustrated, the CubeSat system 2700 includes a communications system 2702, a computer system 2708, a control system 2710, a power system 2712, and a propulsion system 2714.

In an example, the communications system 2702 provides communications with other satellites and/or user equipment such as ground stations. In addition to including a calibration system, the communications system 2702 can include a set of antennas 2704 and a set of transceivers 2706. The set of antennas 2704 supports radio frequencies within a desired frequency spectrum and can be a phased area of antenna elements. The transceivers 2706 can be components of a transponder of the satellite and can include a set of satellite receivers and a set of satellite transmitters. The satellite transmitter(s) may, for example, multiplex, encode, and compress data to be transmitted, then modulate the data to a desired radio frequency and amplify it for transmission over the set of antennas 2704. Multiple channels can be used, in addition to error correction coding. The satellite receiver(s) demodulates received signals and performs any necessary de-multiplexing, decoding, decompressing, error correction and formatting of the signals from set of antennas 2704, for use by the computer system 2708. The set of antennas 2704 and/or the set of transceivers 2706 may also include switches, filters, low-noise amplifiers, down converters (for example, to an intermediate frequency and/or baseband), and/or other communications components. Data decoded by the satellite receiver(s) can be output to the computer system 2708 for further processing. Conversely, an output of the computer system 2708 can be provided to the satellite transmitter(s) for transmission.

The computer system 2708 can be communicatively coupled with the communications system 2702, the control system 2710, and the power system 2712. In an example, the computer system 2708 provides controls over and/or receives and processes data of the communications system 2702, the control system 2710, and the power system 2712. For instance, the computer system can process communications data of the communications system 2702, outputs attitude and position information to the control system 2710, and outputs power distribution controls to the power system 2712.

In an example, the control system 2710 maintains the satellite in a proper position within an orbit by instructing the propulsion system 2714 to control thrusters and/orient the satellite precisely to maintain the proper position. Maintaining the orbit may also include maintaining the desired nodal separations between itself and the other satellites with the satellite constellation. For instance, the control system 2710 includes tracking, telemetry, and processors for calculating and/or receiving attitude and/or orbit adjustment information.

The power system 2712 provides electrical power to other ones of the CubeSat system 2700, including the communications system 2702, the computer system 2708, the control system 2710, and the propulsion system 2714. The power system 2712 may, for example, include one or more solar panels and a supporting structure, and one or more batteries. Telemetry circuits and processors of the power system 2712 can monitor the power collection and the power consumption and can control the collection and the distribution of the electrical power to the other ones of the CubeSat system 2700.

The propulsion system 2714 may include a set of motors and set of thrusters. The propulsion system 2714 may also include a set of fuel sources, such as fuel and oxidant tanks, battery cells, liquid fuel rocket, and/or an ion-thruster system. Telemetry circuits and processors of the propulsion system 2714 can control operations of the motors, thrusters, and/or fuel sources to move and/orient the satellite.

In an example, the computer system 2708 (and, similarly, the remaining ones of the CubeSat system 2700) includes at least a processor, a memory, a storage device, communications peripherals, and an interface bus. The interface bus is configured to communicate, transmit, and transfer data, controls, and commands among the various components of the computer system 2708. The memory and the storage device include computer-readable storage media, such as RAM. ROM, electrically erasable programmable read-only memory (EEPROM), hard drives, CD-ROMs, optical storage devices, magnetic storage devices, electronic non-volatile computer storage, for example FLASH® memory, and other tangible storage media. Any of such computer readable storage media can be configured to store instructions or program codes embodying aspects of the disclosure. The memory and the storage device also include computer readable signal media. A computer readable signal medium includes a propagated data signal with computer readable program code embodied therein. Such a propagated signal takes any of a variety of forms including, but not limited to, electromagnetic, optical, or any combination thereof. A computer readable signal medium includes any computer readable medium that is not a computer readable storage medium and that can communicate, propagate, or transport a program for use in connection with the computer system 2708.

Further, the memory includes an operating system, programs, and applications. The processor is configured to execute the stored instructions and includes, for example, a logical processing unit, a microprocessor, a digital signal processor, and other processors. The communications peripherals are configured to facilitate communications between the computer system 2708 and remaining ones of the CubeSat system 2700 and include, for example, a communications bus and/or a network interface controller, modem, wireless and wired interface cards, antenna, and other communications peripherals.

General Considerations

While the present subject matter has been described in detail with respect to specific aspects thereof, it will be appreciated that those skilled in the art, upon attaining an understanding of the foregoing, may readily produce alterations to, variations of, and equivalents to such aspects. Numerous specific details are set forth herein to provide a thorough understanding of the claimed subject matter. Those skilled in the art will understand that the claimed subject matter may be practiced without these specific details In other instances, methods, apparatuses, or systems that would be known by one of ordinary skill have not been described in detail so as not to obscure claimed subject matter. This disclosure has been presented for the purpose of providing examples rather than limitation, and does not preclude the inclusion of such modifications, variations, and/or additions to the present subject matter as would be readily apparent to one of ordinary skill in the art.

Unless specifically stated otherwise, it is appreciated that throughout this specification discussions utilizing terms such as “processing,” “computing.” “calculating.” “determining,” and “identifying” or the like refer to actions or processes of a computing device, such as one or more computers or a similar electronic computing device or devices, that manipulate or transform data represented as physical electronic or magnetic quantities within memories, registers, or other information storage devices, transmission devices, or display devices of the computing platform. The use of “adapted to” or “configured to” herein is meant as open and inclusive language that does not foreclose devices adapted to or configured to perform additional tasks or steps. Additionally, the use of “based on” is meant to be open and inclusive, in that a process, step, calculation, or other action “based on” one or more recited conditions or values may, in practice, be based on additional conditions or values beyond those recited. Headings, lists, and numbering included herein are for ease of explanation only and are not meant to be limiting.

Aspects of the methods disclosed herein may be performed in the operation of such computing devices. The systems discussed herein are not limited to any particular hardware architecture or configuration. A computing device includes any suitable arrangement of components that provide a result conditioned on one or more inputs. Suitable computing devices include multi-purpose microprocessor-based computer systems accessing stored software that programs or configures the computing system from a general purpose computing apparatus to a specialized computing apparatus implementing one or more aspects of the present subject matter. Any suitable programming, script, or other type of language or combinations of languages may be used to implement the teachings herein in software to be used in programming or configuring a computing device. The order of the blocks presented in the examples above can be varied—e.g., blocks can be re-ordered, combined, and/or broken into sub-blocks. Certain blocks or processes can be performed in parallel.

1. A satellite comprising:
a power source comprising a set of photovoltaic (PV) panels; and
a power system comprising:
a set of rechargeable batteries; and
a set of switching capacitor converters (SCCs), each SCC coupled to the set of rechargeable batteries and at least one PV panel of the set of PV panels, wherein each SCC of the set of SCCs comprises:
a capacitor that is connected to the at least one PV panel in parallel; and
a half-bridge (HB) module that is connected to the capacitor in parallel, wherein the HB module is connected to the set of rechargeable batteries and is configured to supply a current that charges the set of rechargeable batteries.

2. The satellite of claim 1, wherein the set of SCCs are configured to output current to a boost converter that is associated with the set of rechargeable batteries, wherein the set of SCCs comprises a first SCC, a second SCC, and a third SCC, and wherein the first SCC, the second SCC, and the third SCC are connected in series.

3. The satellite of claim 2, further comprising:
a full-bridge (FB) module comprising an inductor, a load, and the set of rechargeable batteries, wherein the FB module is configured to:
track a reference value of the current, wherein the reference value of the current is greater than a maximum amount of a current that the at least one PV panel is configured to provide.

4. The satellite of claim 1, wherein the HB module controls a duty cycle of a first SCC of the set of SCCs, a second SCC of the set of SCCs, and a third SCC of the set of SCCs based on a maximum available amount of power produced by the first SCC, the second SCC, and the third SCC.

5. The satellite of claim 1, wherein the HB module controls a duty cycle of a first SCC of the set of SCCs, a second SCC of the set of SCCs, and a third SCC of the set of SCCs based on a load demand, and wherein the load demand comprises a predetermined output voltage configured to power one or more semiconductor devices.

6. The satellite of claim 1, further comprising:
a sensor; and
a processor communicatively coupled to the sensor and configured to:
receive sensor data from the sensor;
determine an amount of solar irradiation based on the sensor data, wherein the amount of solar irradiation is associated with the at least one PV panel; and
based on a determination that the amount of solar irradiation is below a threshold amount, activate a power-down mode for the at least one PV panel.

7. The satellite of claim 1, wherein the at least one PV panel is a first PV panel, further comprising:
a sensor; and
a processor communicatively coupled to the sensor and configured to:
receive sensor data from the sensor;
determine an amount of solar irradiation based on the sensor data, wherein the amount of solar irradiation is associated with the first PV panel;
based on a determination that the amount of solar irradiation is below a threshold amount, determine whether a current location of the power system is associated with an eclipse period; and
based on a determination that the current location of the power system is associated with an eclipse period, activate a power-down mode for the first PV panel and a second PV panel.

8. The satellite of claim 1, wherein the at least one PV panel is a first PV panel, further comprising:
a sensor; and
a processor communicatively coupled to the sensor and configured to:
receive sensor data from the sensor;
determine an amount of solar irradiation based on the sensor data, wherein the amount of solar irradiation is associated with the first PV panel;
based on a determination that the amount of solar irradiation is below a threshold amount, determine whether a current location of the power system is associated with an eclipse period; and
based on a determination that the current location of the power system is not associated with an eclipse period, deactivate a power-down mode for a second PV panel.

9. The satellite of claim 1, further comprising:
a communications interface; and
a processor communicatively coupled to a sensor and the communications interface, the processor configured to:
receive a signal from a ground station via the communications interface, wherein the ground station is configured to monitor a state of health and operating mode of the power system; and
change, based on the signal, a state of a switch configured to control at least one rechargeable battery of the set of rechargeable batteries from among the set of rechargeable batteries.

10. The satellite of claim 9, wherein the signal from the ground station is triggered in response to a single event upset, a bug detected in system data, or an interruption to a function of the power system.

11. A power system comprising:
a set of rechargeable batteries; and
a set of switching capacitor converters (SCCs) connected in series, each SCC coupled to the set of rechargeable batteries and a power source, wherein each SCC of the set of SCCs comprises:
a capacitor; and
a HB module coupled to the capacitor and comprising a set of switches, wherein the HB module is configured to supply a current that charges the set of rechargeable batteries.

12. The power system of claim 11, wherein the power source comprises a set of PV panels, wherein each SCC is coupled to at least one PV panel, and wherein each SCC operates in a mode of operation based on an amount of solar irradiation received by the at least one PV panel.

13. The power system of claim 11, wherein the HB module comprises a first switch and a second switch, wherein a mode of operation comprises a bypass mode or an insertion mode, wherein the HB module is configured to close the first switch to enter the bypass mode, and wherein the HB module is configured to close the second switch to enter the insertion mode.

14. The power system of claim 11, further comprising a boost converter, wherein the boost converter is connected to the set of SCCs in series and is configured to:
receive the current that charges the set of rechargeable batteries from the HB module, wherein the boost converter is configured to operate in a current control mode, the current control mode comprising a minimum current value, and wherein the minimum current value is greater than a maximum amount of a current that a PV panel is configured to provide.

15. The power system of claim 14, wherein the set of SCCs comprises a first SCC coupled with a first PV panel, a second SCC coupled with a second PV panel, and a third SCC coupled with a third PV panel, wherein the power system is configured to select a mode of operation based on an amount of solar irradiation received by the first PV panel, the second PV panel, or the third PV panel.

16. The power system of claim 15, wherein:
the mode of operation comprises a first mode of operation, a second mode of operation, a third mode of operation, or a fourth mode of operation;
the first mode of operation comprises activating a bypass mode for each of the first SCC, the second SCC, and the third SCC;
the second mode of operation comprises (i) activating an insertion mode for the first SCC and (ii) activating a bypass mode for each of the second SCC and the third SCC;
the third mode of operation comprises (i) activating a bypass mode for each of the first SCC and the second SCC and (ii) activating a bypass mode for the third SCC; and
the fourth mode of operation comprises activating an insertion mode for each of the first SCC, the second SCC, and the third SCC.

17. The power system of claim 16, further comprising a processor coupled to a set of sensors, the processor being configured to:
receive sensor data from the set of sensors;
determine an amount of solar irradiation associated with each of the first PV panel, the second PV panel, and the third PV panel based on the sensor data; and
select the mode of operation based on the amount of solar irradiation associated with each of the first PV panel, the second PV panel, and the third PV panel, wherein selecting the mode of operation comprises:
in response to determining the amount of solar irradiation associated with each of the first PV panel, the second PV panel, and the third PV panel is approximately zero, activating the first mode of operation;
in response to determining (i) the amount of solar irradiation associated with the first PV panel is greater than zero and (ii) the amount of solar irradiation associated with each of the second PV panel and the third PV panel is approximately zero, activating the second mode of operation;
in response to determining (i) the amount of solar irradiation associated with each of the first PV panel and the second PV panel is greater than zero and (ii) the amount of solar irradiation associated with the third PV panel is approximately zero, activating the third mode of operation; and
in response to determining the amount of solar irradiation associated with each of the first PV panel, the second PV panel, and the third PV panel is greater than zero, activating the fourth mode of operation.

18. A SCC of a power system, the SCC comprising:
a capacitor coupled to a PV panel and is configured to store current from the PV panel; and
a HB module coupled to the capacitor and comprising a set of switches, wherein the SCC is coupled to a set of rechargeable batteries and is configured to supply an amount of current to charge the set of rechargeable batteries, and wherein the amount of current is based on an operating mode.

19. The SCC of claim 18, wherein the operating mode is a bypass mode, the bypass mode comprising:
providing, by the PV panel, current to the capacitor; and
wherein the HB module does not discharge any current to charge the set of rechargeable batteries.

20. The SCC of claim 18, wherein the operating mode is an insertion mode, the insertion mode comprising:
providing, by the PV panel, current to the capacitor; and
wherein the HB module discharges the amount of current to charge the set of rechargeable batteries.
